(19) United States
(12) Patent Application Publication
(10) Pub. No.: US 2026/0127340 A1
(43) Pub. Date: May 7, 2026

(54) SPECTROSCOPIC DETECTION OF MATERIALS

(71) Applicants: Jessica White, New York, NY (US); Karen Panetta, Rockport, MA (US); Shishir Paramathma Rao, Woburn, MA (US); Srijith Rajeev, Woburn, MA (US); Sos Agaian, New York, NY (US)

(72) Inventors: Jessica White, New York, NY (US); Karen Panetta, Rockport, MA (US); Shishir Paramathma Rao, Woburn, MA (US); Srijith Rajeev, Woburn, MA (US); Sos Agaian, New York, NY (US)

(21) Appl. No.: 19/381,949

(22) Filed: Nov. 6, 2025

Related U.S. Application Data
(60) Provisional application No. 63/716,869, filed on Nov. 6, 2024.

(51) Int. Cl. G06F 30/27; G06F 111/04; G06F 111/10; G06V 10/147; G06V 10/25; G06V 10/44; G06V 10/58; G06V 10/80

(52) U.S. Cl. CPC G06F 30/27; G06V 10/147; G06V 10/25; G06V 10/457; G06V 10/58; G06V 10/806; G06F 2111/04; G06F 2111/10; G06V 2201/07

(57) ABSTRACT

The present disclosure relates to a system and methodology designed for the spectroscopic detection of materials found on surfaces or dispersed in air. Some embodiments utilize a multi-modal sensor suite that operates through a progressive and multi-level acquisition pipeline, escalating across different sensing modalities such as visible, thermal, and hyperspectral. Data acquired at each level can be fully integrated and fused for efficient and precise material detection. Some embodiments use a physics-constrained computational model that uses latent hypercomplex states and learnable hypercomplex algebra to accurately disentangle and reconstruct spectral signatures, enabling robust substance identification. The system is adaptable to a range of hardware platforms, such as handheld devices, UAVs, and robots.

### TECHNICAL FIELD

This application relates to the use of spectroscopy to detect adulterants on surfaces or in air or other gases.

### BRIEF DESCRIPTION OF THE DRAWINGS

Detailed descriptions of implementations of the present invention will be described and explained through the use of the accompanying drawings.

FIG. 1 is a block diagram that illustrates an example process for applying one or more of the systems and methods herein.

FIG. 2A illustrates an example process for on-device processing according to some embodiments.

FIG. 2B illustrates an example process for external processing according to some embodiments.

FIG. 3 is a block diagram that illustrates various components of a hardware apparatus according to some embodiments.

FIG. 4 illustrates a handheld detection device according to some embodiments.

FIG. 5 illustrates a device included in a UAV according to some embodiments.

FIG. 6 illustrates a movable scanning device according to some embodiments.

FIG. 7 is a block diagram that illustrates an example of machine learning model training according to some embodiments.

FIG. 8A illustrates a functional block diagram of a progressive, multi-level acquisition pipeline. Each “level” is an acquisition configuration that selects one or more sensing modalities and band sets (e.g., visible, thermal, hyperspectral subsets), illumination conditions, and spatial/spectral resolution. The system escalates through levels until a stopping criterion is met, then fuses data collected up to the stopping level for detection.

FIG. 8B depicts a high-level overview of multi-level escalation and fusion, showing the progressive refinement of data acquisition with decision points at each level.

FIG. 8C illustrates escalation thresholds and fusion policy for a progressive pipeline with an arbitrary number K≥2 of levels. At level k, the system configures modalities/bands, captures data, computes features, evaluates a policy πₖ or threshold τₖ, and either stops and fuses or escalates to level k+1. Fusion may be performed at a feature level and/or decision level.

FIG. 9A (Simplified) depicts a high-level block diagram of a generic physics-constrained reconstruction architecture with latent-state encoding and multi-pathway decoding.

FIG. 9B illustrates a generic physics-constrained reconstruction module with explicit constraints on base spectrum, multiplicative absorption, and additive fluorescence pathways for generative disentanglement of physical properties.

FIG. 9C illustrates a quaternion-specific example implementation using a quaternion latent variable (e.g., a QVAE), where quaternion components (w, x, y, z) route to distinct constrained pathways for spectrum disentanglement according to some embodiments.

FIG. 9D depicts a high-level hypercomplex latent-space architecture showing learnable components and their routing through a physics-constrained reconstruction module according to some embodiments.

FIG. 9E is a block diagram of a generic hypercomplex architecture implementing learnable structure constants Cᵢⱼₖ for hypercomplex multiplication used in latent-space operations according to some embodiments.

FIG. 9F depicts a masked-wavelength pretraining policy showing instrument-aware mask selection, application to spectra, reconstruction loss computation, and parameter regularization according to some embodiments.

FIG. 10A illustrates a high-level hypercomplex phase-difference activation mechanism that exploits inter-component phase relations in hypercomplex latent representations according to some embodiments.

FIG. 10B illustrates a quaternion-specific phase-difference activation according to some embodiments.

FIG. 10C illustrates a dimension-agnostic hypercomplex phase-difference activation that generalizes the quaternion case to d-component latent states according to some embodiments.

FIG. 11 is a flowchart that illustrates an example target detection process according to some embodiments.

FIG. 12 is a flowchart that illustrates an example capture process according to some embodiments.

FIG. 13 is a flowchart that illustrates an example AI/ML processing pipeline according to some embodiments.

FIG. 14 is a flowchart that illustrates an example calibration and adaptation process according to some embodiments.

FIG. 15 is a block diagram depicting an embodiment of a computer hardware system configured to run software for implementing one or more of the systems and methods described herein.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

### Definitions

For the purpose of clarity and to establish a consistent framework for understanding the disclosure, the following terms are used throughout this specification and in the appended claims. The definitions provided herein are intended to supplement and clarify, but not to unnecessarily limit, the ordinary meaning of these terms as understood by one of ordinary skill in the art. As used herein, terms have the following meanings unless the context indicates otherwise. Where symbols are introduced (e.g., Cᵢⱼₖ, h), they are illustrative, and other notations may be used.

Physics-constrained computational model. A parameterized mapping implemented in software, firmware, or hardware that incorporates known physical structure via one or more of: (i) explicit constraints (non-negativity, smoothness, band-limits, conservation laws), (ii) penalty terms or regularizers in a training objective, (iii) architecture choices that encode physical relationships (e.g., multiplicative absorption vs. additive fluorescence channels), or (iv) constrained or projected optimization during inference or training. The model may be machine-learned or hand-specified, and includes, without limitation, neural networks (convolutional, recurrent, transformer, spiking), hybrid physics-ML models, and other parameterized models that satisfy the foregoing.

Latent hyercomplex state. A d-component latent vector h=(h₀, h₁, . . . , h_{d-1})∈ [symbol] comprising a scalar component h₀ and one or more imaginary components h₁, . . . , h_{d-1}. Supported dimensions include d∈{2, 4, 8} (e.g., complex-like, quaternion-like, octonion-like), but other dimensions are permitted unless expressly limited. The latent dimension may be denoted D interchangeably with d.

Learnable hypercomplex algebra; structure constants. A set of trainable parameters Cᵢⱼₖ (“structure constants”) defining multiplication among components of a d-component latent state. Products between two latent states u, v∈ [symbol] are defined by learnable structure constants Cᵢⱼₖ according to

$${( u ★ v )}_{i} = {\sum }_{j = 0}^{d - 1} {\sum }_{k = 0}^{d - 1} {C}_{ijk} {u}_{j} {v}_{k} ,$$

where C∈ [symbol]
.

The algebra may be associative or non-associative (with a fixed bracketing policy); constraints (e.g., normalization, orthogonality, bounded magnitude, bounded operator norm, sparsity) may be applied during training.

Hypercomplex convolution. A convolutional operation on grouped spectral (or feature) channels in which kernel-input interactions are computed via the learnable hypercomplex product defined by the structure constants Cᵢⱼₖ. Grouping may be fixed or learned, and may align with contiguous or non-contiguous wavelength bands.

Phase-difference activation. An activation that uses the relative phase between the scalar component h₀ and one or more imaginary components hₘ of a latent state h to produce an activated state. The phase of a pair (h₀, hₘ) may be computed by any well-defined mapping (e.g., φₘ=atan 2(∥hₘ∥+ε,∥h₀∥+ε), with ε>0), and the activation may apply a bounded nonlinearity and optional amplitude shaping to functions of one or more phase differences.

Latent-state estimator. Any differentiable or algorithmic mapping that computes a latent state (optionally hypercomplex) from input spectra or features, without limitation to a particular architecture (including, for example, CNNs, transformers, MLPs, spiking networks, or non-NN parametric models).

Fusion operators. μ_{fuse} and ψ_{fuse} denote generic feature- and decision-level fusion functions. For levels L₁ . . . Lₖ producing features F₁ . . . Fₖ and/or decisions D₁ . . . Dₖ, μ_{fuse} (F₁ . . . Fₖ) yields fused features and ψᵤₛₑ (D₁ . . . Dₖ, optional fused features) yields a fused decision. Specific instances are illustrative and non-limiting.

Progressive (multi-level) scanning level. An acquisition configuration that specifies one or more sensing modalities, wavelength bands, illumination conditions, spatial/spectral resolution, dwell time, and lor motion/pose. A progressive pipeline escalates through levels until a stopping criterion or stopping criteria are met; performed levels may be fused.

Stopping policy; threshold. A rule πₖ or threshold τₖ is evaluated after acquiring level-k data to decide whether to stop and fuse or escalate to level k+1. The rule may depend on features, model scores, uncertainty, operational constraints, or any combination thereof.

Base reflectance spectrum; absorption profile; fluorescence profile. In a physics-motivated disentanglement, a measured or reconstructed spectrum S_{recon}(λ) is modeled as S_{recon}(λ)=S_{base}(λ)·A(λ)+F(λ), where S_{base}(λ) is a base reflectance spectrum, A(λ) is a multiplicative absorption/attenuation profile, and F (λ) is an additive fluorescence/emission profile. Constraints may include non-negativity and smoothness for A(λ), and band-limited support for F(λ). Unless noted otherwise, the base reflectance term is denoted R(λ) (also referred to herein as S_{base}(λ)); the two notations are interchangeable.

Band-limited. Having substantially all spectral energy confined to a specified set B of wavelength intervals; outside B, the magnitude is zero or below a small tolerance ε. The set B may be predetermined or learned.

Emission band set B. A collection of wavelength intervals [λₐ, λ_{b}] that define permitted emission/fluorescence bands for F(λ). B may be instrument-specific or material-specific. B can be specified or learned during training.

Operator-norm bound. A constraint that limits the norm of a linear operator (e.g., a weight matrix W) to be at or below a threshold, such as ∥W∥≤τ for a chosen induced or spectral norm, enforced by penalties, projections, or normalization.

Attenuation vector/absorption profile: used interchangeably to denote A(λ).

Emission profile/fluorescence: used interchangeably to denote F(λ).

Grouped spectral bands. A partition or assignment of spectral channels into groups for processing (e.g., for hypercomplex convolution). Groups may correspond to contiguous intervals, disjoint intervals, or learned assignments.

Target substance. Any analyte, constituent, contaminant, additive, adulterant, or material signature intended to be detected, localized, or quantified in a scene or target area.

### Overview

Although several embodiments, examples, and illustrations are disclosed below, it will be understood by those of ordinary skill in the art that the present disclosure extends beyond the specifically disclosed embodiments, examples, and illustrations and include other uses and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments. In addition, embodiments can comprise several novel features and no single feature is solely responsible for its desirable attributes or is essential to practicing the presently disclosed technology.

Foodborne pathogens, environmental contaminants, and so forth pose a significant risk to human health. Current approaches to detecting potentially harmful substances can be effective, but have several drawbacks. For example, significant time may be required to obtain results, testing may require reagents that can be in short supply, and so forth. For example, during the COVID-19 pandemic, testing was at times difficult to obtain due to a lack of available test supplies.

Foodborne illnesses can be introduced at many points from production to the table. For example, fruits and vegetables can become contaminated if unclean water is used for irrigation, washing, etc. Animals can pass disease to other animals, to eggs, etc. During animal processing, unsanitary practices can result in microbes from intestines, skin, etc., contacting and contaminating meat and poultry. Contaminated surfaces on production lines, in storage containers, etc., can lead to significant contamination of food products. Poor refrigeration practices during transportation and storage can provide an opportunity for bacteria to grow. Improperly cleaned delivery vehicles can result in contamination. During preparation, contaminated cutting surfaces, utensils, knives, slicers, etc., can result in food contamination and contribute to the spread of foodborne illness.

Inspections can help ensure that sound food safety practices are followed, but food borne illness outbreaks nonetheless occur with some regularity. For example, in 2022 and 2023 in the United States, there were documented multi-state outbreaks of Listeria, norovirus, Salmonella, hepatitis A, and E. coli.

Early detection can have significant business and health implications. For example, if contamination is detected early, a production line can be stopped and cleaned, contaminated products can be discarded and so forth, before contaminated food makes its way to consumers or before large numbers of consumers have been exposed.

Healthcare-associated infections (HAIs) cause significant mortality and morbidity and result in significant healthcare expenditures. Many HAIs are caused by drug resistant pathogens, such as antibiotic resistant bacteria (e.g., MRSA). HAIs can arise from surgical procedures, central line insertions, catheter insertions, contact with contaminated surfaces, and so forth. Reducing the number of HAIs can improve patient outcomes, reduce healthcare costs, and so forth. However, it can be difficult to detect targets that are associated with HAIs, and such targets may be present in a number of locations. For example, targets can be present on high touch surfaces such as bed railings and gloves, on human tissue such as skin, and so forth. Some embodiments herein can be used to reduce central line-associated bloodstream infections (CLABSIs), catheter-associated urinary tract infections (CAUTIs), surgical site infection, infections due to contact with contaminated surfaces, and so forth.

The systems and methods described herein can be used to identify potential HAI organisms. For example, the systems and methods described herein can be used to detect potential HAI organisms before catheter or central line insertion. For example, the systems and methods herein can be used to scan a sterile field, which can include skin near the insertion site, surrounding surfaces such as bed railings, linens, hospital gowns, PPE, equipment, tools, and/or any other surface that may be interacted with during insertion.

Skin has a natural microbiome and the organisms, which may be harmless when living on the skin, can cause infection if allowed to enter the body. Thus, ensuring that the skin is properly cleaned before performing a procedure can be significant. However, current approaches often rely on assumptions that cleaning and disinfecting procedures are adequate, without testing to verify this is true, which can potentially lead to infection.

In some embodiments, the systems and methods herein can be used to detect potential HAI microbes prior to a procedure, during a procedure, or both. For example, the systems and methods herein can be used to detect potential HAI microbes in an operating room, procedure room, healthcare office, etc. The systems and methods herein can be used to scan a room (e.g., an operating room), surgical tools and/or equipment, and so forth prior to beginning a procedure. In some embodiments, the systems and methods herein can be used during a procedure, for example to detect if a sterile site has become non-sterile.

While medical procedures are often performed in hospitals or other medical facilities, in some cases, such facilities may be unavailable, for example during rescue operations, in war zones, and so forth. Medical procedures may be performed in the open, in ambulances, or other potentially unhygienic settings. The systems and methods herein can be used to detect potential HAI microbes to help ensure that sterile conditions are achieved and/or maintained, including under potentially unhygienic circumstances.

In some embodiments, sterility check data can be logged. In some embodiments, sterility check data can be associated with a patient. In some embodiments, sterility check data can be stored as part of an electronic health record for a patient. It can be significant to ensure that sterility check data is stored in a manner that complies with relevant privacy and/or security regulations, such as HIPAA.

In some embodiments, the systems and methods described herein can enable the detection of viruses, bacteria, fungi, protozoa, helminths, etc. For example, in some embodiments, the systems and methods herein can be used to detect the presence of coagulase-negative staphylococci, Escherichia coli, Enterococcus faecalis, Klebsiella spp., Candida albicans, Enterobacter spp., Serratia spp., Pseudomonas aeruginosa, Norovirus, Group B streptococci, Acinetobacter spp., Candida glabrata, Citrobacter spp., Enterococcus faecium, Viridans group streptococci, Rothia mucilaginosa, Clostridium perfringens, Salmonella spp., Campylobacter spp., Toxoplasma gondii, Listeria monocytogenes, Clostridium spp., Clostridioides difficile, and/or other potentially harmful viruses, bacteria, etc. In some embodiments, the systems and methods described herein can enable the detection of allergens, toxins, human waste, animal waste, chemicals, metabolites, proteins, prions, lipids, amino acids, genetic material, compound molecules, cosmetics, and so forth.

Conventional testing approaches utilize surface swabs, oral swabs, skin swabs, fluid samples (e.g., saliva, urine, blood, wastewater, etc.), and so forth to detect the presence of potentially harmful substances. Advantageously, the systems and methods herein can function on a wide variety of surfaces, with gases, with liquids, etc., which can make testing significantly easier, faster, less error prone, and so forth. The systems and methods herein can enable testing that would otherwise be difficult or impossible, such as rapid testing of a sterile field, detection of a variety of potentially harmful substances in areas such as warzones, and so forth. The systems and methods herein can be used to detect harmful substances in the air, on food products, at surgical sites, and so forth, which can help to prevent or reduce illness. In some embodiments, the systems and methods herein can be used for monitoring, for example to monitor disease outbreaks, such as by analyzing human or animal waste.

In some embodiments, the systems and methods herein can be used for analysis of human tissue, fluids, waste products, etc. For example, the systems and methods herein can be used to analyze skin, blood, sputum, urine, or fecal matter. Advantageously, the systems and methods herein can be used on a person directly (e.g., by collecting data from a patient's skin) or using samples. Similarly, non-human tissue, fluids, waste products, etc., can be analyzed. As an example, respiratory tissue can be analyzed to detect the presence of respiratory diseases, or udders can be analyzed to detect substances that could contaminate milk products.

In some embodiments, the approaches herein can be used to analyze plant materials, either in sample form or as intact plants or plant parts. For example, the systems and methods described herein can be used to analyze leaves, roots, root vegetables, stalks, and so forth, for example to detect the presence of pesticides, harmful bacteria, fungi, and so forth.

The systems and methods herein are not limited to plant and animal tissue. The systems and methods herein can, in some embodiments, be used to detect potentially harmful substances present on fabrics, nitrile, rubber, latex, plastics, metals, wood, agar, paper, in solutions, and so forth.

As described herein, the systems and methods herein can be deployed in a multitude of environments such as, for example and without limitation, healthcare settings (e.g., hospitals, nursing homes, ambulatory centers, doctor's offices, clinics, etc.), emergency vehicles, in the open (e.g., streets, fields, battlefields, etc.), farms, production plants, transport vehicles, restaurants, homes (e.g., home kitchens), pharmaceutical plants, laboratories, bioreactors, and so forth.

In clinical diagnostics, the systems and methods herein can be used to test samples of tissue acquired from humans or animals. Samples can remain in their initial collection vessels or be transferred to alternative storage, such as new containers, slides, petri dishes, test tubes, or serum tubes. Samples can be tested at the location where they were collected or transferred to a lab for testing. A device or an external computer can be tuned to the specified range for a specific test, and the sample can be scanned for target non-self substances, including organisms, chemicals, compounds, proteins, lipids, or any other target.

While many examples herein relate to detecting substances that could harm human health, the systems and methods described herein are not limited to such scenarios. For example, the systems and methods herein can be used in sensitive manufacturing processes. As an example, semiconductor manufacturing processes can fail if contaminated precursors are used in production, or steel used in construction can be more likely to bend or break if the steel is contaminated. These are merely examples, and the skilled artisan will readily appreciate other applications of the systems and methods described herein.

Advantageously, the systems and methods herein may not require sample collection. Rather skin, udders, solid surfaces, fabrics, etc., can be scanned directly without requiring samples to be collected, which can provide improvements in speed, accuracy, reliability, etc., as simpler processes can be used, the use of reagents is not required, shipping to a laboratory is not needed, and so forth.

### Hyperspectral Imaging

Hyperspectral imaging is a technology that captures and processes information across a wide spectrum of light. Unlike traditional imaging, which typically captures images at limited wavelengths and bins wavelengths together (e.g., into red, green, and blue channels, which encompass a range of wavelengths), hyperspectral imaging collects data from across the electromagnetic spectrum at specific wavelengths. Hyperspectral images can be used to identify materials, monitor processes, and so forth. Each pixel in a hyperspectral image contains a spectrum of data, which can be analyzed to determine, for example, materials present in a sample.

Hyperspectral imaging has a broad range of applications. For example, in agriculture, it can be used to monitor crop health, detect diseases, and optimize the use of fertilizers and water. As another example, in environmental monitoring, hyperspectral imaging helps to assess the health of ecosystems, track pollution or allergens, and so forth. Hyperspectral imaging can be used for monitoring and detection of diseases or substances that can cause illness, such as bacteria or viruses in water or on food products.

Hyperspectral imaging can be used to produce a three-dimensional hyperspectral cube (e.g., two spatial dimensions and one wavelength dimension). Hyperspectral imaging devices can typically scan with small band widths (e.g., about 1 nm) and across a variety of wavelengths which can include, for example, ultraviolet, visible, near infrared, short wavelength infrared, medium wavelength infrared, long wavelength infrared, and/or far infrared.

Some embodiments herein utilize hyperspectral imaging techniques and hardware for the detection of target substances (generally referred to as targets herein). Other techniques are also possible, such as multispectral imaging. Multispectral imaging is similar to hyperspectral imaging, but band widths may be larger (e.g., 20 nm steps instead of 1 nm steps), wavelength ranges may not be as wide, etc. Techniques such as multispectral imaging may be cheaper than hyperspectral imaging and can be suitable for certain applications, but may not be suitable for other applications where more detailed information, such as can be obtained through hyperspectral imaging, is needed. Unless clearly indicated otherwise, the techniques herein can be used in conjunction with hyperspectral data, multispectral data, RGB data, etc., though it will be appreciated that having less available data may not be suitable in all circumstances or for all types of detection or analysis.

While reference is made to hyperspectral imaging, it will be appreciated that the approaches herein are not limited to analyzing images. For example, in some cases, spatial distribution may not be considered, and analysis can be performed on spectral data alone. However, in some cases, using spatial information can be significant. For example, spatial distribution can indicate an extent of contamination. Spatial information can, in some cases, help to identify a substance. For example, two compounds may have similar hyperspectral signatures, but typically have different sizes, clustering characteristics, and so forth. In such cases, spatial information can help to differentiate between the two compounds. In some embodiments, spatial information can increase confidence in detected compounds.

In some embodiments, spectral data can be mapped to a latent hypercomplex state h=(h₀, h₁, . . . , h_{d-1}) comprising a scalar component h₀ and one or more imaginary components h₁, . . . , h_{d-1}, where the dimension d is selectable (e.g., 2 (complex), 4 (quaternionic), or 8 (octonionic)). A learnable hypercomplex algebra defines multiplication among components by trainable structure constants Cᵢⱼₖ. A physics-constrained reconstruction module that computes a base reflectance spectrum S_{base} (λ), a multiplicative absorption profile A(λ) constrained to be non-negative and spectrally smooth, and an additive fluorescence profile F(λ) constrained to be band-limited in emission regions; reconstruction follows Srecon (λ)=S_{base}(λ)·A (λ)+F (λ).

Progressive multi-level acquisition (e.g., visible, then thermal/selected HSI, then full HSI/NIR) reduces capture/compute cost, and a phase-difference hypercomplex activation can use phase relations between the scalar and imaginary components to model interdependencies in spectra.

### Hardware Systems

Detecting substances can be beneficial in a variety of environments, such as in medical settings, in public spaces, in war zones, in factories, in commercial kitchens, at home, and so forth. Accordingly, it can be significant to implement the systems and methods described herein in a variety of hardware configurations.

In some embodiments, devices can be provided for a variety of different environments. These devices can take many forms, including drones (autonomous or human-controlled), robots (autonomous or human-controlled), handheld devices, mounted devices, etc., or can be integrated into pre-existing devices such as cell phones or medical equipment. Micro-electro-mechanical systems (MEMS) can be used in some devices to reduce size and cost. The sensor can be miniaturized and configured with proprietary spectral ranges tailored specifically for target detection applications. Devices can include communications hardware, which can be wired or wireless, with data transmission options including Wi-Fi, Bluetooth, Bluetooth Low Energy, cellular, radio frequency, mobile ad hoc networks, wireless ad hoc networks, ethernet, etc.

In some implementations, the systems and methods herein can be implemented in an unmanned aerial vehicle (UAV), which can be autonomous or human controlled. The UAV can include various sensors, such as a hyperspectral or multispectral sensor, one or more environmental sensors, etc. In some embodiments, the UAV can include one or more light sources. In some embodiments, various sensing and/or lighting components can be movable. For example, in some implementations, sensors, lights, etc., can translate along one or more axes and/or rotate around one or more axes. In some embodiments, a UAV can fly within an environment and can scan for one or more specified targets. In some embodiments, scans can be initiated manually by a person. In some embodiments, scans can be scheduled. In some embodiments, scans can be carried out autonomously. In some embodiments, the systems and methods herein can be implemented in a ground-based robot, which can be autonomous or human-controlled. Such a ground-based robot can include features that are similar to or the same as those found on a UAV, and can include, for example, telescoping, rotation, etc.

In some embodiments, the system comprises a multi-modal sensor suite to capture a richer set of data. For example, the system can integrate multiple sensors including a visible-spectrum (e.g., RGB) sensor for initial broad scanning, a thermal sensor for temperature-based analysis, selected hyperspectral imaging (HSI) bands for intermediate spectral detail, a full hyperspectral sensor combined with a near-infrared (NIR) microscope for high-fidelity spectral resolution, or any combination thereof. Data from the visible-spectrum sensor can be used for rapid object identification and context, while data from the thermal sensor provides temperature information that influences spectral signatures, and the hyperspectral and NIR sensors enable detailed material characterization. The fusion of these modalities within the machine learning model enables more robust and accurate detection than is possible with a single sensor type. Other sensors can be used additionally or alternatively, such as a shortwave infrared sensor, mid-wavelength infrared sensor, or long-wavelength infrared sensor.

To improve efficiency and reduce cost, some embodiments can implement a “multi-layer multi-spectral decomposition” acquisition strategy with progressive scanning levels. In this strategy, a first-pass scan (Level 1) can be performed using broadband lighting and a computationally inexpensive RGB sensor to identify potential anomalies and regions of interest (ROIs). If sufficient data is obtained for analysis, Level 1 data can be fused for final detection. Otherwise, a second-pass scan (Level 2) can add thermal sensors and selected HSI bands under mixed lighting to analyze ROIs in greater detail, with Level 1 and Level 2 data fused if adequate. If additional resolution is required, a third-pass scan (Level 3) can employ full HSI sensors, an NIR microscope, and fluorescent lighting on ROIs, fusing all levels for comprehensive analysis. This targeted, multi-level approach significantly reduces the amount of data to be processed and allows for the efficient use of specialized, high-cost sensors only where needed.

In some embodiments, the systems and methods herein can be implemented in a handheld device or device that is mounted to or forms part of other equipment, such as a smartphone, medical device, etc. In some embodiments, the systems and methods herein can be implemented in a self-contained handheld device, which can, in some embodiments, include a display configured to display analysis results. Depending upon the specific device, the display can include a screen capable of displaying a variety of information such as an LCD or OLED display. In some implementations, results can be displayed using individual LEDs, such as single LED or set of LEDs whose on/off state(s) and/or color(s) indicate a test result, device status, etc.

In some embodiments, data processing functionality can be included in a device. In some embodiments, data processing functionality can be implemented on an external system, such as a laptop, desktop, smartphone, tablet, cloud server, etc., configured to receive data collected from a device.

Detecting a target substance under controlled conditions (e.g., controlled temperature, humidity, lighting, etc.) presents several challenges, as described herein. In some cases, it can be desirable to detect a target substance without the advantage of having controlled environmental conditions, which can present additional challenges. In some embodiments, environmental sensors can collect data about the environment such as temperature, humidity, surface moisture, environmental lighting, pressure, and so forth. This information can be used to help identify substances present in a sample, on a surface, etc.

The system can include a dynamic light source capable of adjusting its emission (e.g., wavelengths) to optimize the detection of one or more target substances. The dynamic light source can fine-tune illumination properties to match particular requirements and/or advantageous configurations for a particular application and/or for characteristics of a target substance. In some embodiments, the system includes a mechanism for wavelength-specific measurements of light emitted by the light source, light captured by the sensor, or both. This can enable more precise calibration and adjustments of the system's optical parameters, which can improve detection accuracy.

In some embodiments, tailored illumination is used to customize the light's properties based on the specific application or target substance. Adjusting the illumination enables the system to be fine-tuned for performance in diverse environments. This adaptability can be important for maintaining high detection accuracy across various conditions by compensating for environmental factors that may adversely affect sensing capabilities.

In some embodiments, adaptive filtering systems are included in the hardware to allow real-time or nearly real-time dynamic adjustment of filters based on feedback from one or more artificial intelligence (AI) algorithms. In some embodiments, the system utilizes “smart” materials or electronically controlled filters to achieve rapid adaptation. Adaptive filters can modify their optical properties electronically, enabling the system to respond quickly to changes in the scene or target characteristics without the need for mechanical filter changes, although in some embodiments, different physical filters can be utilized. For example, a system can be configured to automatically select an appropriate physical filter based on the scene or target characteristics.

In some embodiments, tunable optical materials (TOMs) are used in hyperspectral imaging to provide dynamic adjustment of wavelength and spectral sensitivity. The use of TOMs can allow a system to adjust its optical properties based on the scene or target of interest being imaged and/or in response to feedback from an AI model, without changing physical components. This can improve efficiency and flexibility, enabling optimized imaging performance tailored to specific detection tasks.

In some embodiments, a device may not include a lighting source, and can instead rely on ambient lighting, or a device can be configured to use ambient lighting when such lighting is available and can use a built-in light source when needed or advantageous (e.g., when there is insufficient ambient light or when ambient light doesn't have sufficient intensity at certain wavelengths). For example, when operating outdoors, a UAV, robot, or other device may take advantage of sunlight. When lighting conditions are poor, a device can use a built-in light source.

The devices herein can be used to detect targets using reflection, transmission, absorption, or any combination thereof. In some embodiments, a device is designed to scan surfaces such as skin, food products, etc., and can analyze reflected light to determine if a target is present.

The foregoing hardware may be embodied as (i) a handheld unit, (ii) a UAV or other mobile platform, (iii) a ground robot or movable scanning device, or (iv) a mounted or integrated accessory for existing equipment (e.g., smartphone, medical device, or production-line fixture). On-device (“edge”) processing can utilize the device's processing circuitry to generate results locally; alternatively or additionally, results can be computed off-device and returned via a wired or wireless communications module, although in some other embodiments results are not transmitted back to the device. Where results may include protected or sensitive information, transmissions and storage can employ privacy- and security-preserving workflows (e.g., encrypted transport, authenticated access, and HIPAA-compliant handling when applicable).

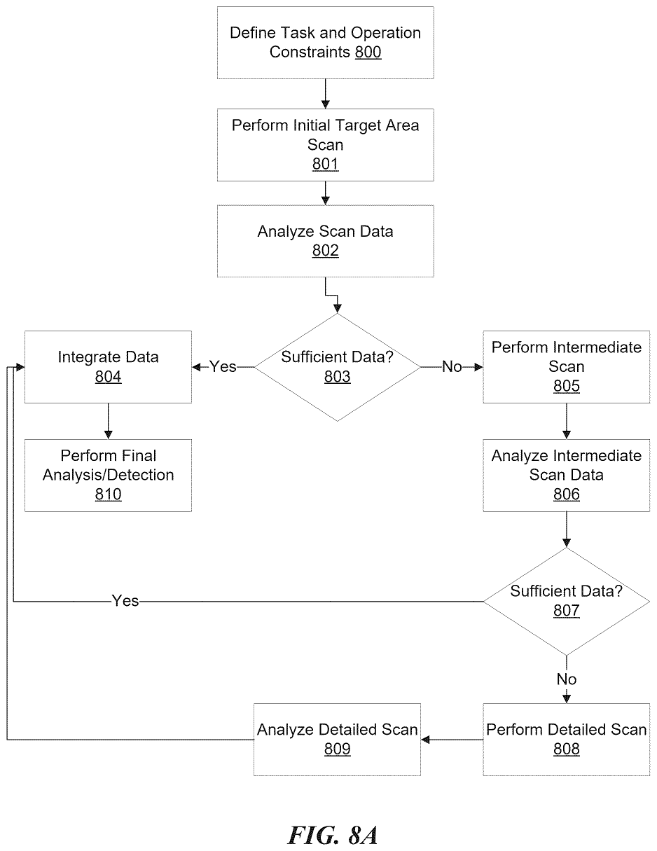

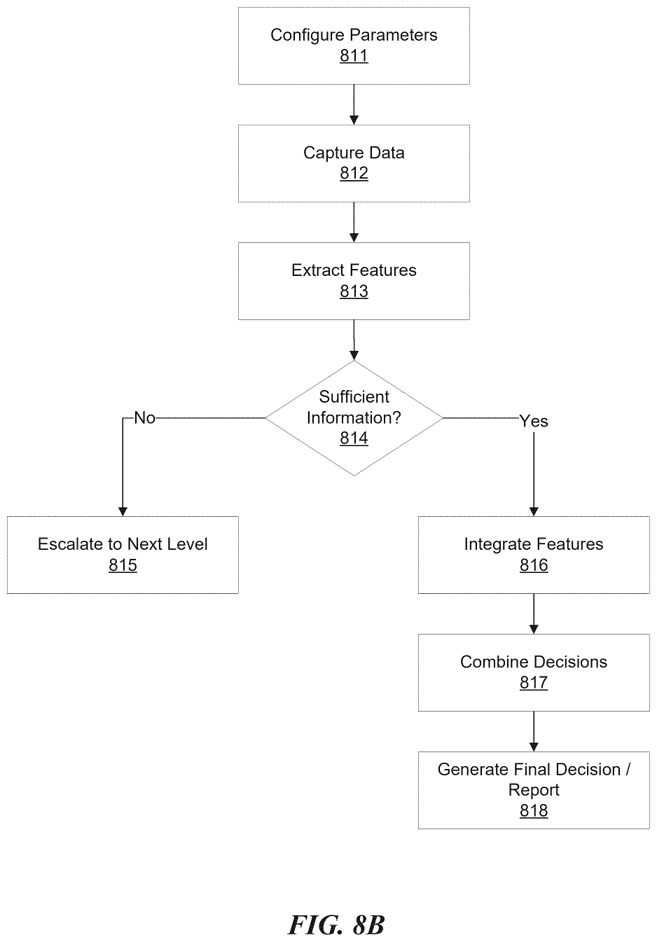

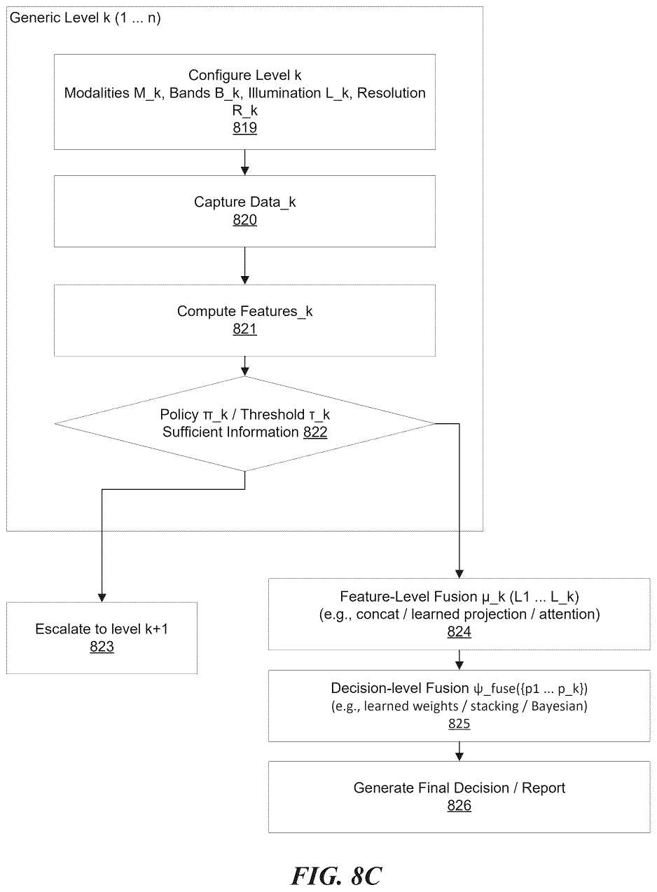

In some embodiments, the processor can derive capture-control metrics from a latent hypercomplex state h, such as entropy or confidence of the absorption profile A, fluorescence energy ∫F, or a detector score computed from h. If a metric falls below a threshold, the system can adjust one or more capture settings for a subsequent scan of the same ROI—e.g., increases blue-band lamp intensity, narrows a tunable band-pass filter around absorption peaks, or extends integration time. This can close a sensing—inference control loop in which the disentangled representation directly governs illumination intensity, wavelength selection, and exposure for the next pass. This sensing-inference control loop can correspond to the decision/evaluation nodes in FIG. 8A, which govern escalation and parameter retuning across acquisition levels.

### Machine Learning

A significant challenge with conventional testing is the need to acquire a sample for testing. Sampling can take significant time, be prone to errors if individuals collecting samples lack proper training or expertise, and so forth. For example, in the case of a sample collection using a swab, if the swab is not in contact with the surface long enough, is not moved around sufficiently, comes into contact with other surfaces, etc., results can be compromised. For example, a contaminated surface can appear clean if not swabbed properly, or a clean surface can appear contaminated if the swab is contaminated by contact with other surfaces, fluids, etc. In some cases, analysis can be carried out on byproducts such as wastewater, but this may be less than ideal in some circumstances as testing may only be performed under limited circumstances, for example when food products are washed. Sample collection and processing times may render testing infeasible under certain circumstances, such as when inserting a central line or catheter, performing a surgical procedure, etc. Such testing may be especially difficult or impossible when testing is needed in more remote locations such as farm fields, warzones, and so forth.

Performing testing directly on surfaces of interest such as skin, meat, vegetables, etc., can be beneficial but presents many challenges. For example, it can be challenging to separate skin's natural microbiome from targets, separate a signature of a target from proteins and other substances that naturally occur in meat and poultry products, and so forth.

In some embodiments, the approaches herein can use one or more trained machine learning models to identify targets using spectral data, spatial data, etc. Some embodiments can be used to detect the presence of non-self entities on living or formerly living surfaces. In some embodiments, the systems and methods herein detect irregularities or differences from non-living materials. In some embodiments, the systems and methods herein integrate hyperspectral (HS) sensors and imaging with artificial intelligence (AI) architectures, which can include machine learning and deep learning.

This generic framework can be implemented in various ways (e.g., autoencoders or other architectures) and may serve as the foundation for illustrative generative models such as a Quaterion Variational Autoencoder (QVAE). The QVAE leverages quaternion algebra to process hyperspectral data in a four-dimensional hypercomplex space, enabling the capture of multi-dimensional interrelationships that extend beyond real and complex numbers. A quaternion is a hypercomplex number defined as Q=w+xᵢ+yⱼ+zₖ, where w, x, y, z are real-valued components, and i, j, k are imaginary units satisfying i²=j²=k²=i j k=−1. Quaternion operations include addition (Q₁±Q₂=(w₁±w₂)+(x₁±x₂)i+(y₁±y₂)j+(z₁±z₂)k), scalar multiplication (λQ=λw+λxᵢ+λyⱼ+λzₖ), conjugation (Q*=w−xᵢ−yⱼ−zₖ), norm (|Q|=√(w²+x²+y²+z²)), and non-commutative multiplication via the Hamilton product. The Hamilton product for Q₁⊗Q₂ is defined as: Q₁⊗Q₂=(w₁w₂−x₁x₂−y₁y₂−z₁z₂)+(w₁x₂+x₁w₂+y₁z₂−z₁y₂)i+(w₁y₂−x₁z₂+y₁w₂+z₁x₂)j+(w₁z₂+x₁y₂−y₁x₂+z₁w₂)k. This product enforces cross-axis interactions, allowing quaternions to model rotations and correlations not possible in real-valued domains. In the QVAE, hyperspectral spectral bands are divided into four groups and mapped to the quaternion's components (w for real, x, y, z for imaginary), preserving physical correlations between wavelengths. The latent-state estimator maps a raw hyperspectral signal—a high-dimensional real-valued vector—to a single latent quaternion, where each component is guided to represent distinct physical properties, such as absorption or emission profiles.

Quaternion convolution extends this algebra to neural network operations, providing a parameter-efficient alternative to real-valued convolution. If W=W_{w}+iWₓ+jW_{y}+kW_{z} and I=I_{w}+iIₓ+jI_{y}+kI_{z} are two quaternions, then quaternion convolution 0=W_{*H} I (Hamilton-product-induced) has components

$${O}_{w} = {W}_{w} * {I}_{w} - {W}_{x} * {I}_{x} - {W}_{y} * {I}_{y} - {W}_{z} * {I}_{{z}^{′}} \\ {O}_{x} = {W}_{w} * {I}_{x} + {W}_{x} * {I}_{w} + {W}_{y} * {I}_{z} - {W}_{z} * {I}_{{y}^{′}} \\ {O}_{y} = {W}_{w} * {I}_{y} - {W}_{x} * {I}_{z} + {W}_{y} * {I}_{w} + {W}_{z} * {I}_{{x}^{′}} \\ {O}_{z} = {W}_{w} * {I}_{z} + {W}_{x} * {I}_{y} - {W}_{y} * {I}_{x} + {W}_{z} * {I}_{{w}^{′}}$$

and the quaternion output is O=O_{w}+iOₓ+jO_{y}+kO_{z}. This can be represented in matrix form as a 4×4 transformation that combines four ordinary convolutions with additions and subtractions, reducing the parameter count by a factor of four (e.g., 4 parameters instead of 16 for equivalent real-valued weights). For hyperspectral data, bands are grouped into four parts (e.g., related wavelengths for physical coherence), assigned to quaternion axes, and convolved to exploit inter-band correlations. This convolution can capture spectral interdependencies while maintaining spatial context, enabling efficient processing of high-dimensional data with lower computational overhead.

Furthermore, the system is not limited to standard quaternion algebra. The principles of hypercomplex convolution can be extended to other 4-dimensional algebras, (e.g., reduced bi-quaternions, double-complex numbers, Clifford-type variants) each defined by component-interaction rules. These rules can be encoded compactly as a sign/weight matrix that modulates the Hamilton-product terms. In a learnable generalization, the fixed sign matrix can be replaced with a real-valued parameter matrix that is constrained (e.g., to ±1 or to a bounded range) or regularized during training, allowing the model to adapt the multiplication rules to the task while remaining stable. For example, the standard multiplication for various quaternion like numbers can be represented as:

$$Quaternions [ \begin{matrix}𝕣 & - 𝕩 & - 𝕪 & - 𝕫 \\ 𝕩 & 𝕣 & - 𝕫 & 𝕪 \\ 𝕪 & 𝕫 & 𝕣 & - 𝕩 \\ 𝕫 & - 𝕪 & 𝕩 & 𝕣\end{matrix} ] ⊗ [ \begin{matrix}ℛ \\ 𝒳 \\ 𝒴 \\ 𝒵\end{matrix} ] ( [ \begin{matrix}1 & - 1 & - 1 & - 1 \\ 1 & 1 & - 1 & 1 \\ 1 & 1 & 1 & - 1 \\ 1 & - 1 & 1 & 1\end{matrix} ] . [ \begin{matrix}𝕣 & 𝕩 & 𝕪 & 𝕫 \\ 𝕩 & 𝕣 & 𝕫 & 𝕪 \\ 𝕪 & 𝕫 & 𝕣 & 𝕩 \\ 𝕫 & 𝕪 & 𝕩 & 𝕣\end{matrix} ] ) ⊗ [ \begin{matrix}ℛ \\ 𝒳 \\ 𝒴 \\ 𝒵\end{matrix} ] \\ Reduced biquaternions [ \begin{matrix}𝕣 & - 𝕩 & 𝕪 & - 𝕫 \\ 𝕩 & 𝕣 & 𝕫 & 𝕪 \\ 𝕪 & - 𝕫 & 𝕣 & - 𝕩 \\ 𝕫 & 𝕪 & 𝕩 & 𝕣\end{matrix} ] ⊗ [ \begin{matrix}ℛ \\ 𝒳 \\ 𝒴 \\ 𝒵\end{matrix} ] ( [ \begin{matrix}1 & - 1 & 1 & - 1 \\ 1 & 1 & 1 & 1 \\ 1 & - 1 & 1 & - 1 \\ 1 & 1 & 1 & 1\end{matrix} ] . [ \begin{matrix}𝕣 & 𝕩 & 𝕪 & 𝕫 \\ 𝕩 & 𝕣 & 𝕫 & 𝕪 \\ 𝕪 & 𝕫 & 𝕣 & 𝕩 \\ 𝕫 & 𝕪 & 𝕩 & 𝕣\end{matrix} ] ) ⊗ [ \begin{matrix}ℛ \\ 𝒳 \\ 𝒴 \\ 𝒵\end{matrix} ] \\ Double - complex [ \begin{matrix}𝕣 & 𝕩 & - 𝕪 & - 𝕫 \\ 𝕩 & 𝕣 & - 𝕫 & - 𝕪 \\ 𝕪 & 𝕫 & 𝕣 & 𝕩 \\ 𝕫 & 𝕪 & 𝕩 & 𝕣\end{matrix} ] ⊗ [ \begin{matrix}ℛ \\ 𝒳 \\ 𝒴 \\ 𝒵\end{matrix} ] ( [ \begin{matrix}1 & 1 & - 1 & - 1 \\ 1 & 1 & - 1 & - 1 \\ 1 & 1 & 1 & 1 \\ 1 & 1 & 1 & 1\end{matrix} ] . [ \begin{matrix}𝕣 & 𝕩 & 𝕪 & 𝕫 \\ 𝕩 & 𝕣 & 𝕫 & 𝕪 \\ 𝕪 & 𝕫 & 𝕣 & 𝕩 \\ 𝕫 & 𝕪 & 𝕩 & 𝕣\end{matrix} ] ) ⊗ [ \begin{matrix}ℛ \\ 𝒳 \\ 𝒴 \\ 𝒵\end{matrix} ] \\ {HCA}_{4} [ \begin{matrix}𝕣 & - 𝕩 & - 𝕪 & 𝕫 \\ 𝕩 & 𝕣 & 𝕫 & 𝕪 \\ 𝕪 & 𝕫 & 𝕣 & 𝕩 \\ 𝕫 & - 𝕪 & - 𝕩 & 𝕣\end{matrix} ] ⊗ [ \begin{matrix}ℛ \\ 𝒳 \\ 𝒴 \\ 𝒵\end{matrix} ] ( [ \begin{matrix}1 & - 1 & - 1 & 1 \\ 1 & 1 & - 1 & 1 \\ 1 & 1 & 1 & 1 \\ 1 & - 1 & - 1 & 1\end{matrix} ] . [ \begin{matrix}𝕣 & 𝕩 & 𝕪 & 𝕫 \\ 𝕩 & 𝕣 & 𝕫 & 𝕪 \\ 𝕪 & 𝕫 & 𝕣 & 𝕩 \\ 𝕫 & 𝕪 & 𝕩 & 𝕣\end{matrix} ] ) ⊗ [ \begin{matrix}ℛ \\ 𝒳 \\ 𝒴 \\ 𝒵\end{matrix} ]$$

where the sign matrix defines the interaction rules for each component.

In some embodiments, latent states are represented as h=(h₀, h₁, . . . , h_{d-1})∈ [symbol] comprising a scalar channel h₀ and d−1 imaginary channels, where d is selectable (e.g., d∈{2, 4, 8}). Products between two latent states u, v∈ [symbol] are defined b learnable structure constants Cᵢⱼₖ according to

$${( u ⋆ v )}_{i} = {\sum }_{j = 0}^{d - 1} {\sum }_{k = 0}^{d - 1} {C}_{ijk} {u}_{j} {v}_{k} ,$$

where C∈ [symbol] is trained jointly with other network parameters. The tensor C may be constrained during training by (i) bounded magnitude, (ii) operator-norm control via normalization of matricized slices, and/or (iii) an orthogonality deviation penalty (e.g., ∥MTM−I∥ for a suitable matricization of C). Initialization can use a known algebra (e.g., quaternion) and then permit learned deviations. Gradients through * are computed by automatic differentiation; ∂(u*v)/∂Cᵢⱼₖ=uⱼvₖ. When d=4 and C is fixed to Hamilton constants, * reduces to the quaternion product; when d=8, C can encode a non-associative octonion-like product with a fixed bracketing policy. For d=8 octonionic embodiments, multiplications are evaluated with a left-associated bracketing ((u*v)*w) for determinism across layers. In variants, a small, learnable gate selects among a fixed set of bracketings, with a regularizer penalizing frequent switching.

In a parameter-efficient variant, Cᵢⱼₖ is factorized as Cᵢⱼₖ=GᵢⱼHᵢⱼₖ, where Hᵢⱼₖ are fixed structure constants (e.g., Hamilton) and G∈R^{d×d} is a learnable gate; this recovers the element-wise modulation of the standard 4×4 multiplication matrix described herein. The hypercomplex product * is used inside latent-space layers. In an affine variant, an output channel yᵢ may be computed as yᵢ=(u*v)ᵢ+bᵢ. In a convolutional variant, feature maps Xⱼ filtered by kernels Wₖ are combined via Cᵢⱼₖ as Yᵢ=Σ_{j,k}Cᵢⱼₖ(Xⱼ*Wₖ), where * denotes spatial/spectral convolution. This realizes hypercomplex convolution over grouped spectral bands. S_{recon}(λ)=S_{base}(λ)·A(λ)+F(λ).

In some embodiments, the reconstruction module composes a set of physically interpretable terms computed from the latent hypercomplex state, including at least (i) a multiplicative attenuation term A(λ) constrained to be non-negative and spectrally smooth, and (ii) an additive emission term F(λ) constrained to be band-limited. It will be appreciated that the reconstruction model can compose different terms in some alternative embodiments.

The reconstructed spectrum S_{recon}(λ) is obtained by combining these terms with a base reflectance term S_{base}(λ) according to a selected physical model. Unless expressly limited, references to an ‘attenuation’ term A(λ) encompass absorption and, in certain embodiments, scattering contributions modeled multiplicatively, additively, or via wavelength-coupled mixing. Illustrative non-limiting examples include:

$$Absorption - only : {S}_{recon} ( λ ) = {S}_{base} ( λ ) \cdot A ( λ ) + F ( λ ) . \\ Multiplicative scattering : {S}_{recon} ( λ ) = {S}_{base} ( λ ) \cdot [ A ( λ ) \cdot {A}_{scat} ( λ ) ] + F ( λ ) . Path radiance : {S}_{recon} ( λ ) = {S}_{base} ( λ ) \cdot A ( λ ) + F ( λ ) + H ( λ ) . \\ Wavelength - coupled : {S}_{recon} ( λ ) = {S}_{base} ( λ ) \cdot A ( λ ) + F ( λ ) + \int K ( λ , {λ}^{′} ) {S}_{base} ( {λ}^{′} ) d {λ}^{′}$$

(or a corresponding discrete summation over bands).

In discrete form, let R∈ [symbol] be the discrete reflectance over B spectral bands with centers {λ₁, . . . , λ_{B}}, and let K∈ [symbol] {B×B} be a learned (or specified) scattering kernel. For each b∈{1, . . . , B},

$${( KR )}_{b} = {\sum }_{{b}^{′} = 1}^{B} {K}_{{bb}^{′}} \cdot {R}_{{b}^{′}} .$$

To promote physically plausible wavelength coupling, impose one or more of the following constraints on K: (i) banded support: −|b−b′|>w⇒K_{b b′}=0, (ii) non-negativity: −K_{b b′}≥0, (iii) row-sum bound: −

$${\sum }_{{b}^{′} = 1}^{B} {K}_{{bb}^{′}} \leq κ , \qquad ( iv )$$

smoothness across λ:

$$- {TV}_{rows} ( K ) = {\sum }_{b = 1}^{B} {\sum }_{{b}^{′} = 1}^{B - 1} \vert {K}_{b ( {b}^{′} + 1 )} - {K}_{{bb}^{′}} \vert$$

(similarly for columns), or (v) near-symmetry for isotropy: −∥K−K^{T}∥_{F}≤ε_{sym}. Some efficient implementations can use banded matrix-vector multiplies or 1-D convolutions along the spectral axis; gradients propagate through K jointly with the rest of the model.

In an illustrative embodiment, the neural network is configured to utilize a learnable quaternionic hypercomplex algebra, where the algebraic rules are not fixed but are instead parameterized and optimized during model training. Instead of a fixed sign vector (e.g., [1, −1, −1, −1] for standard quaternions), the system employs a learnable parameter vector, [a₁, a₂, a₃, a₄], for each part of the multiplication rule. These parameters a₁, a₂, a₃, a₄ are treated as trainable weights and are updated via backpropagation along with the other network weights. This allows the neural network to discover and define an optimal, task-specific algebra for representing the intricate physical relationships within the hyperspectral data. For instance, the parameters [a₁, a₂, a₃, a₄] can be constrained to be either 1 or −1, forcing the network to select the best algebra from a discrete set of predefined structures. Alternatively, the parameters can be continuous values within a certain range (e.g., [−1, 1]), allowing the network to learn a “soft” or hybrid algebraic structure. This adaptability enables the model to create representations that are more powerful and tailored to the specific problem of generative disentanglement than any single, predefined hypercomplex algebra.

$$Learnable Quaternions [ \begin{matrix}𝕣 & - 𝕩 & - 𝕪 & - 𝕫 \\ 𝕩 & 𝕣 & - 𝕫 & 𝕪 \\ 𝕪 & 𝕫 & 𝕣 & - 𝕩 \\ 𝕫 & - 𝕪 & 𝕩 & 𝕣\end{matrix} ] ⊗ [ \begin{matrix}ℛ \\ 𝒳 \\ 𝒴 \\ 𝒵\end{matrix} ] ( [ \begin{matrix}{a}_{1} & {a}_{2} & {a}_{3} & {a}_{4} \\ {b}_{1} & {b}_{2} & {b}_{3} & {b}_{4} \\ {c}_{1} & {c}_{2} & {c}_{3} & {c}_{4} \\ {d}_{1} & {d}_{2} & {d}_{3} & {d}_{4}\end{matrix} ] . [ \begin{matrix}𝕣 & 𝕩 & 𝕪 & 𝕫 \\ 𝕩 & 𝕣 & 𝕫 & 𝕪 \\ 𝕪 & 𝕫 & 𝕣 & 𝕩 \\ 𝕫 & 𝕪 & 𝕩 & 𝕣\end{matrix} ] ) ⊗ [ \begin{matrix}ℛ \\ 𝒳 \\ 𝒴 \\ 𝒵\end{matrix} ]$$

The learnable hypercomplex algebra provides significant advantages over fixed algebras in spectroscopic applications. Fixed algebras, such as standard quaternions, impose rigid mathematical structures that may not optimally capture the complex, non-linear interactions present in hyperspectral data from diverse materials and adulterants. By contrast, the learnable algebra adapts its multiplication rules during training to better model the physical properties of spectral signatures, such as absorption, fluorescence, and scattering. This results in superior disentanglement performance, where the network can more accurately separate base material spectra from adulterant signatures, even in challenging scenarios involving overlapping spectral features or environmental variations. For example, in food safety applications, the learnable algebra can optimize to distinguish subtle adulterant peaks from natural variations in meat or produce spectra, achieving higher detection accuracy and lower false positive rates compared to fixed-algebra approaches.

To illustrate the learnable algebra constraints and implementation, consider the following pseudocode example for a quaternion multiplication with fully learnable parameters. In this embodiment, the learnable algebra is defined by a 4×4 matrix of trainable parameters that modulate the standard quaternion multiplication rules:

```
def learnable_quaternion_multiplication(q1, q2, learnable_matrix):
  # q1 = [w1, x1, y1, z1], q2 = [w2, x2, y2, z2]
  # learnable_matrix is a 4×4 matrix of trainable parameters:
  # [[a₁, a₂, a₃, a₄],
  # [b₁, b₂, b₃, b₄],
  # [c₁, c₂, c₃, c₄],
  # [d₁, d₂, d₃, d₄]]
  # Construct the standard quaternion multiplication matrix for q1
  standard_matrix = [
    [q1[0], -q1[1], -q1[2], -q1[3]], # w component
    [q1[1], q1[0], -q1[3], q1[2]], # x component
    [q1[2], q1[3], q1[0], -q1[1]], # y component
    [q1[3], -q1[2], q1[1], q1[0]] # z component
  ]
  # Element-wise multiply learnable_matrix with standard_matrix
  effective_matrix = [[learnable_matrix[i][j] * standard_matrix[i][j]
```

for j in range(4)] for i in range(4)]

```
  # Apply the effective matrix to q2
  result = [sum(effective_matrix[i][j] * q2[j] for j in range(4))
      for i in range(4)]
  return result # [w, x, y, z]
# Example constraint implementations:
# Unconstrained: params ∈ [symbol]   (full continuous optimization)
# Bounded: params ∈ [−2, 2] (prevent extreme values)
# Discrete: params ∈ {−1, 0, 1} (select from limited algebra set)
# Normalized: params normalized so each row sums to 1
# Illustrative example: Initialization strategy
# One way to initialize the learnable_matrix is to start with values that replicate standard
# quaternion multiplication,# allowing the network to learn deviations from this baseline.
For instance:
# learnable_matrix = [
# [1, −1, −1, −1], # Matches standard w component signs
# [1, 1, −1, 1], # Matches standard x component signs
# [1, 1, 1, −1], # Matches standard y component signs
# [1, −1, 1, 1] # Matches standard z component signs
# ]
# This provides a stable starting point for optimization.
# Illustrative example: Regularization to prevent overfitting
# To enhance training stability, one approach is to apply gradient clipping during
backpropagation.
# For example, after computing gradients for learnable_matrix, clip them to a maximum
norm:
# grad_norm = sqrt(sum(grad**2 for row in learnable_matrix_grad for grad in row))
# if grad_norm > max_norm (e.g., 1.0):
# learnable_matrix_grad = [[grad * max_norm / grad_norm for grad in row] for row in
learnable_matrix_grad]
# This prevents explosive gradients while allowing the algebra to adapt.
# Generalized hypercomplex multiplication
# u, v: [B, d]; C: [d, d, d] learnable structure constants
def hprod(u, v, C):
  # (u * v)_i = Σ_j Σ_k C[i,j,k] * u_j * v_k
  return einsum(‘ijk,bj,bk->bi’, C, u, v)
```

This pseudocode implements the fully parametric hypercomplex multiplication and also shows an illustrative example of fully parametric quaternion multiplication where all 16 parameters (a₁ through d₄) are learnable, allowing the network to discover completely novel algebraic structures beyond standard quaternions. The learnable matrix modulates each term of the standard Hamilton product, enabling the optimization of custom multiplication rules tailored to the spectral disentanglement task. During training, gradients flow through all parameters, adapting the algebra to maximize disentanglement performance.

In some embodiments, to further enhance the network's capabilities, novel hypercomplex phase-difference activation functions are utilized. Let h=(h₀, h_{I}) denote a latent hypercomplex state with scalar h₀ and imaginary vector h_{I}=(h₁, . . . , h_{d-1}). Define φ₀=atan 2(∥h_{I}∥+ε,h₀) and φₘ=atan 2(∥hₘ∥+ε,∥h₀∥+ε). The activation computes Δφₘ=φₘ−φ₀ and outputs

$${h}_{0}^{′} = {f}_{0} ( {h}_{0} ) , {h}_{m}^{′} = {a}_{m} ( \vert {h}_{m} \vert ) \cdot g ( {Δφ}_{m} ) , \\ m = 1 , … , d - 1$$

where g is a bounded nonlinearity (e.g., tanh, sigmoid) and aₘ is an amplitude shaping function (e.g., identity, softplus, or a small learned gate). This construction is differentiable almost everywhere, numerically stabilized by ε≥0, reduces to the quaternion-specific case when d=4, and applies unchanged to complex (d=2) and octonionic (d=8) embodiments. Unlike standard activation functions like ReLU, which operate on real scalars, these functions process the entire quaternion, leveraging its multi-dimensional nature. This allows the network to model complex rotations and interdependencies inherent in spectral data, which are opaque to real-valued networks, thereby improving disentanglement of physical properties.

In some embodiments, distinct components of the latent hypercomplex state h=(h₀, h₁, . . . , h_{d-1}) are decoded into interpretable terms via mappings A(λ)=f_{A}(h₀; θ_{A}) (multiplicative attenuation),

$$F ( λ ) = {\sum }_{m = 1}^{d - 1} {f}_{F}^{( m )} ( {h}_{m} ; {θ}_{F}^{( m )} )$$

(additive emission), with optional H(λ)=f_{H}(h;θ_{H}), K(λ, λ′)=f_{K}(h; θ_{K}). The learnable hypercomplex algebra, parameterized by structure constants Cᵢⱼₖ, governs latent-space interactions (including hypercomplex convolution) prior to decoding; for example,

$${( u ⋆ v )}_{i} = {\sum }_{j = 0}^{d - 1} {\sum }_{k = 0}^{d - 1} {C}_{ijk} {u}_{j} {v}_{k} .$$

To manage gauge freedoms between R(λ) and A(λ), the decoder may impose simple normalizations such as [symbol] R [symbol] _{λ}=1(unit-mean reflectance) or A(λ₀)=1 at a reference wavelength λ₀, which improve identifiability during training without limiting generality.

The activation is dimension-agnostic and algebra-agnostic, operating on the latent components regardless of whether multiplication in latent layers is real, quaternionic, octonion-like, or defined by learned structure constants Cᵢⱼₖ. Invariants such as joint rescaling of (h₀, h_{I}) can be controlled by the choice of aₘ and f₀. Practical variants include, for example, (i) temperature-scaled g(Δφₘ/τ) for sharper/softer phase sensitivity, (ii) clamping Δφₘ to avoid branch-cut issues, and (iii) small learnable offsets in φ₀ to absorb sensor bias.

In the quaternion case q=w+ix+jy+kz, phases may be computed component-wise {φ_{w}, φₓ, φ_{y}, φ_{z}}, with deltas Δφ_{xw}, Δφ_{yw}, Δφ_{zw} formed relative to φ_{w}. The activated output then follows q′=[f₀(w), aₓ(|×|)g(Δφ_{xw}), a_{y}(|y|)g(AΔφ_{yw}), a_{z}(|z|)g(Δφ_{zw})], which is equivalent to the general form with d=4 under an appropriate choice of φ₀.

By way of illustration and not limitation, one embodiment employs a quaternion-latent variational autoencoder (QVAE) as the latent-state estimator. In that case, training can be made tractable via a two-stage process. In a first stage, a Masked Autoencoder (MAE) is pre-trained on a massive, unlabeled dataset to learn a powerful general-purpose spectral representation. In a second stage, the pre-trained MAE latent-state estimator is used to initialize the QVAE's latent-state estimator, which is then fine-tuned with the physics-constrained reconstruction module on the task of generative disentanglement. This is merely an illustrative architecture; other models may be substituted without departing from the scope of the present disclosure, and the same regimen leverages self-supervised pre-training for the subsequent, structured physical inference task.

In some embodiments, during pretraining, the system masks contiguous spectral intervals to create a self-supervised reconstruction task. Let Δλ denote an instrument's spectral sampling (or FWHM). A mask-length distribution P(L) is defined with an expected length [symbol] [L] calibrated to instrument spacing (e.g., a truncated geometric or normal distribution with [symbol] [L]≈2-4 bands). For each spectrum, the trainer selects a number of intervals K (e.g., by a Poisson or geometric rule), samples L₁, . . . , L_{K}˜P(L), and masks K contiguous wavelength spans at random, optionally enforcing a target mask fraction ρ per spectrum. For co-registered multimodal inputs (e.g., visible+thermal+HSI subsets), masking may be applied jointly across modalities along the shared wavelength axis, or independently per modality, depending on the alignment strategy.

In some embodiments, the model predicts the masked spectral segments from the unmasked context, and the training objective combines reconstruction with physics regularization as

$${L}_{total} = {L}_{recon} + {λ}_{1} {‖ \partial A / \partial λ ‖}_{1} + {λ}_{2} {\sum }_{λ ∉ B} \vert F ( λ ) \vert + {λ}_{3} ( {‖ {M}^{T} M - I ‖}_{F}^{2} + {Ω}^{op} ( C ) ) + {λ}_{4} {‖ \partial {A}_{s} / \partial λ ‖}_{1} + {λ}_{5} {ℛ}_{K} ( K ) + {λ}_{6} {‖ H ‖}_{1} ,$$

subject to A(λ)≥0, Aₛ(λ)≥0, and a banded, bounded-scatter kernel K with |b−b′|>w⇒K_{bb′}=0 and row-sum constraints Σ_{b′}K_{bb′}≤κ. Here, L_{recon} is an [symbol] / [symbol] reconstruction loss over masked bins; B is the emission band set; M is a chosen matricization of the structure-constants tensor C; Ω^{op}(C) enforces operator-norm control (e.g., spectral normalization) for stability; Aₛ denotes multiplicative scattering; H denotes additive path radiance; and [symbol] (K) collects kernel regularizers, e.g.

$${ℛ}_{K} ( K ) = {α}_{1} {‖ K ∘ {W}_{off} ‖}_{1} + {α}_{2} TV ( K ) + {α}_{3} {\sum }_{b} max ( 0 , {\sum }_{{b}^{′}} {K}_{b {b}^{′}} - κ ) + {α}_{4} {‖ K - {K}^{T} ‖}_{F}^{2} ,$$

which encourage bandedness (via a fixed off-band mask W_{off}), smoothness across wavelengths (total variation TV), bounded row sums, and near-symmetry for isotropic regimes. Hyperparameters λ₁, . . . , λ₆ and α₁, . . . , α₄ are selected by validation, and constraints may be enforced by projection (e.g., non-negativity clamps) or barrier/penalty methods.

The system can log a histogram of sampled lengths L during training to verify conformance to P(L) and to the instrument's Δλ/FWHM. This prevents collapse to trivially short or unrealistically long masks and documents the policy used for model selection and reproducibility.

For hyperspectral images, masking can be applied along the spectral axis per pixel or per region-of-interest (ROI). Spatial neighborhoods may share mask indices to encourage consistency across adjacent pixels, while escalation policies (see multi-level acquisition discussion herein) can adapt P(L) and K to the current level's band set and resolution.

Furthermore, AI algorithms may incorporate meta-learning, transfer learning, etc., to enhance adaptability across different tasks and environments. By leveraging prior knowledge gained from previous tasks, the system can quickly adapt to new targets or conditions with without a large amount of additional training.

A machine learning model can be trained on a wide variety of data so that the machine learning model performs well across a range of samples. For example, for detecting a target in or on human skin, it can be important to have skin samples from a wide variety of individuals, as people have different pore sizes/distributions, skin discolorations, scars, vessel structures, skin tones, hair, wrinkles, etc. By using a large number of samples, a machine learning model can learn to differentiate between natural variation in human skin and targets. Similarly, meat can have different muscle strand sizes, marbling, etc., and a machine learning model can be trained to differentiate between natural variations in the appearance and makeup of meat and targets that can be present on meat.

Analyzing such complex data can have high computing resource demands, which can make it infeasible to perform such analysis as costs may be too high, results may take too long to obtain, analysis may need to be offloaded to external systems such as cloud servers with dedicated GPUs or ML processing capabilities, and so forth. Advantageously, using the machine learning methods described herein, complex data can be analyzed more quickly and more efficiently, making it viable to detect targets in highly complex environments such as on human skin.

### Data Preparation and Signature Prediction

Detecting targets presents many challenges. For example, there are many materials and surfaces that can be encountered. In some embodiments, a simulation model can predict a target fingerprint on a variety of surfaces, including surfaces that have not previously been encountered. In some embodiments, models can be generalizable. For example, hyperspectral unmixing can be used to remove background data so that a machine learning model can focus on identifying a target regardless of the background. In hyperspectral unmixing, each pixel in a hyperspectral image can be decomposed into a set of spectral signatures known as endmembers. The endmembers can represent pure materials present in the image. For example, a pixel that includes water and diesel can be decomposed into a spectral signature for water and a spectral signature for diesel.

In some embodiments, endmembers or potential endmembers can be identified or selected. For example, if it is known that an image is of human skin, endmembers for skin can be selected. Reducing the number of potential endmembers can reduce the computational demands to identify materials. A mathematical mixing model can be used to represent how the end members combine to form the mixed pixels. A mixing model can, in some embodiments, be a linear mixing model, though other techniques are possible. Some examples of unmixing algorithms include, for example and without limitation, linear spectral unmixing, non-negative matrix factorization, and sparse unmixing. An unmixing model can determine each end member's contribution to the image.

In some embodiments, a system can be configured to perform unmixing, and analysis can be performed on the unmixed spectra (e.g., what remains after known materials are removed), to identify targets in the image or to determine if a specified target is present in the image. That is, the background spectra can be removed, thus enabling analysis of only spectral contributions from materials not in the background.

In some embodiments, the background can be determined based on a known substrate (e.g., skin, steel, aluminum, wood, etc.) or can be determined by analyzing an image.

Another issue is that a machine learning model can be trained to identify targets using a training dataset, but if the target is an organism, the organism can evolve over time, making the model less accurate as the organism becomes less like the organisms depicted in training data.

In some embodiments, software can be updated (e.g., updates can be pushed to devices or devices can request software updates), which can include information for new materials, evolved organisms, and so forth. In some embodiments, mutations are monitored for target pathogens, for example based on information from PulseNet provided by the Centers for Disease Control and Prevention or similar bodies. In some embodiments, simulation models are used to predict how mutations will alter a target's hyperspectral fingerprint. In some embodiments, models can be updated. For example, a machine learning model can be trained with additional training samples so that the model can detect mutations or mutated organisms.

In some embodiments, neural networks are trained on data obtained under modified lighting conditions. This training approach allows the AI algorithms to account for changes in spectral signatures that result from adjustments in the illumination provided by a dynamic light source or from variations in environmental lighting. By incorporating these factors into the training data, neural networks can become more robust and adaptable to different operating conditions.

In some embodiments, AI algorithms are configured to account for changes in spectral signals due to light modification, surface texture variations, and/or other environmental factors. This adaptability can be achieved via the use of advanced machine learning techniques that adjust model parameters in real time based on input data and feedback from additional sensors monitoring ambient conditions. A self-calibration process can occur before data capture, allowing the system to optimize settings for current environmental conditions. In some embodiments, a self-calibration process can occur after capture, and measurements can be adjusted based on the results of the self-calibration process in a post-processing step.

In some embodiments, after capturing data, the system utilizes calibration routines within one or more AI models to adjust for the effects of filters, TOMs, etc., used in the imaging process. These calibration routines can compensate for alterations and effects introduced by the adaptive filtering systems, which can help to ensure that processed data accurately reflects the true spectral characteristics of the target substance(s).

### Example Embodiments

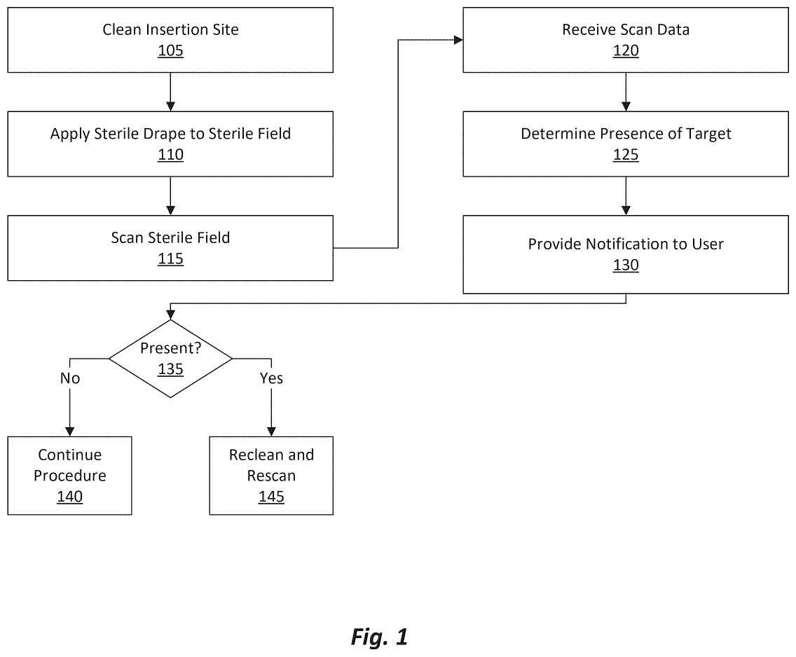

FIG. 1 is a block diagram that illustrates an example process for applying one or more of the systems and methods herein. In FIG. 1, the systems and methods herein are used to detect a target (e.g., fungi, virus, bacteria, etc.) prior to a procedure such as a catheter or central line insertion.

At operation 105, a medical professional can clean an insertion site. At operation 110, the medical professional can apply a sterile drape, which can define or form part of the sterile field. At operation 115, the medical professional can scan the sterile field, for example using a device as described herein or another suitable device. In some embodiments, the medical professional can use a handheld device with a detector configured to capture light reflected from a patient's skin or other objects in the sterile field. At operation 120, the device or a processing system (e.g., an external server, which can be a cloud server in some embodiments, a smartphone, tablet, laptop, etc.) can receive the scan data. At operation 125, the device or the processing system can determine the presence of one or more targets and can, at operation 130, provide a notification to the medical professional. At operation 135, if no targets were detected, the medical professional can continue the procedure at operation 140. If one or more targets were detected, the medical professional can reclean the sterile field and rescan the sterile field at operation 145. The process can continue until a clean sterile field is established and the procedure is performed.

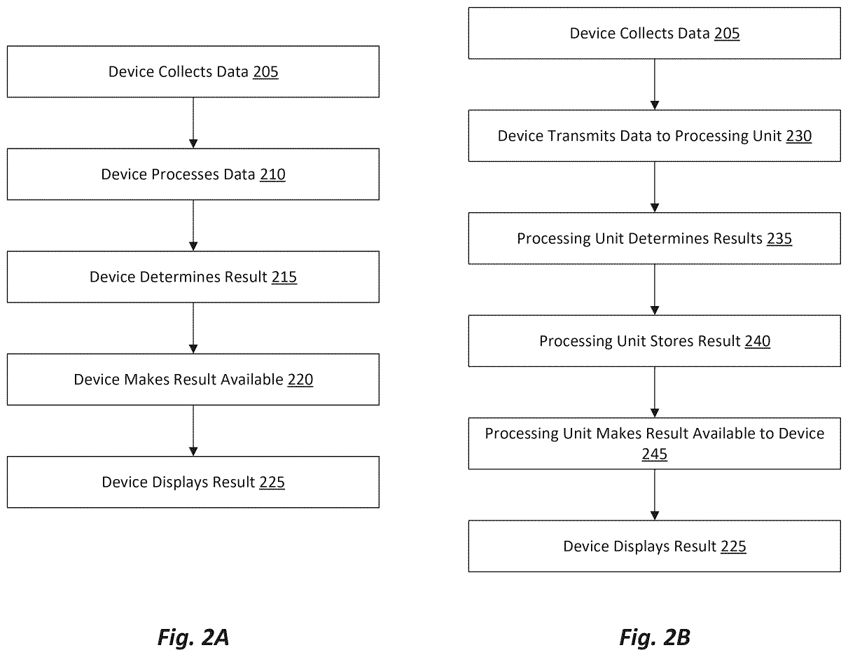

FIGS. 2A and 2B depict example processes for collecting and analyzing hyperspectral data according to some embodiments. FIG. 2A illustrates an example process for on-device processing according to some embodiments. FIG. 2B illustrates an example process for external processing according to some embodiments. Turning first to FIG. 2A, at operation 205, a device can collect data. The device can include a hyperspectral sensor and/or other hardware, for example as described herein. At operation 210, the device can process the collected data and, at operation 215, the device can determine a result, such as the presence or absence of one or more targets. At operation 220, the device can make the results available. For example, the device can make the results available for display, transfer to an external system, writing to internal storage, etc. At operation 225, the device can display the result if the device includes a display. In some embodiments, the device may not include a display, and the results can be accessed by an external system that can display the results.

FIG. 2B is generally similar to FIG. 2A, except that processing steps are performed on an external processing unit such as a server, laptop, desktop, smartphone, tablet, etc. At operation 205, the device can collect data. At operation 230, the device can transmit the data to the processing unit. In some embodiments, the device can transfer data wirelessly, for example over Wi-Fi, Bluetooth, NFC, cellular, or any other wireless transmission means. In some embodiments, the device can transfer data over a wired connection, such as ethernet, USB-C, Thunderbolt, etc. At operation 235, the processing unit (e.g., an application running on the processing unit) can analyze the data to determine a result. At operation 240, the processing unit can store the result. At operation 245, the processing unit can make the result available to the device, which can display the result at operation 225. In some embodiments, results may not be transmitted to the device. For example, results may instead be shown on a smartphone display, laptop display, etc.

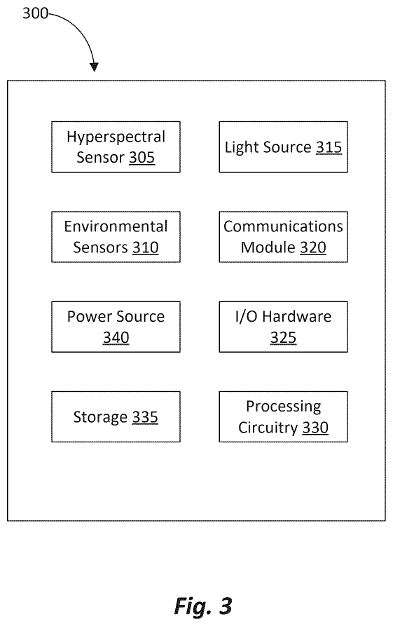

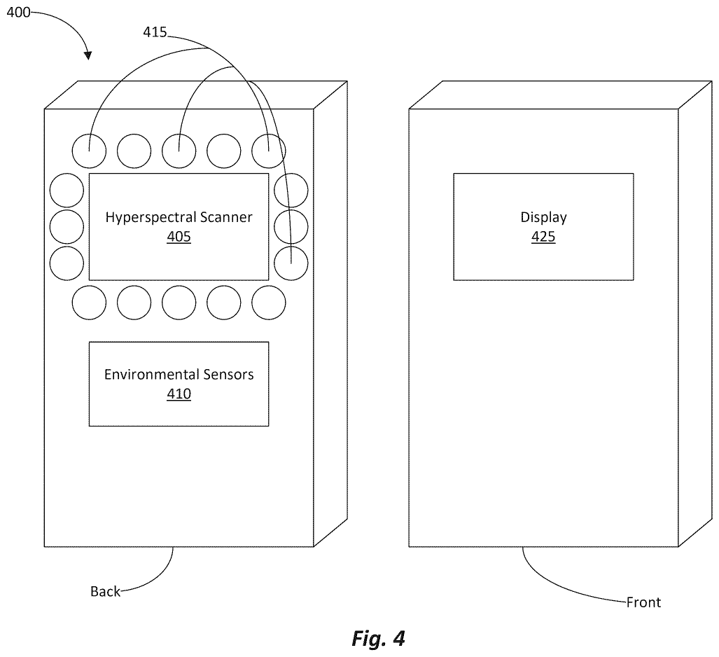

FIG. 3 is a block diagram that illustrates various components of a hardware apparatus according to some embodiments. The apparatus 300 can include a hyperspectral sensor 305, one or more environmental sensors 310 (e.g., temperature sensor, humidity sensor, etc.), light source 315 (e.g., one or more LEDs, lamps, etc.), communications module 320 (e.g., ethernet, Wi-Fi, Bluetooth, etc.), I/O hardware 325 (e.g., a USB controller, Thunderbolt controller, built-in display, etc.), processing circuitry 330 (e.g., an SOC, microprocessor, field programmable gate array, etc.), storage 335 (e.g., for storing results, analysis routines, control programs, etc.), and a power source 340 (e.g., a battery, solar panel and associated circuitry, or connection to an external power source). Different embodiments of the apparatus 300 can include different, fewer, and/or additional components.

FIG. 4 illustrates a handheld detection device 400 according to some embodiments. A back surface of the handheld detection device 400 can include a hyperspectral scanner 405, one or more environmental sensors 410, and a light source 415 (e.g., an array of LEDs or other light emission sources). The front of the handheld detection device 400 can include a display 425. The display can provide instructions, display results, etc. The display, scanner, sensors, and light source can be disposed on different sides than those shown in FIG. 4, although it can be advantageous to place the light source 415 and hyperspectral scanner 405 on the same side. There can be multiple types of sensors, such as RGB sensors, multispectral sensors, or infrared sensors (e.g., near-, shortwave-, or long-wavelength infrared sensors).

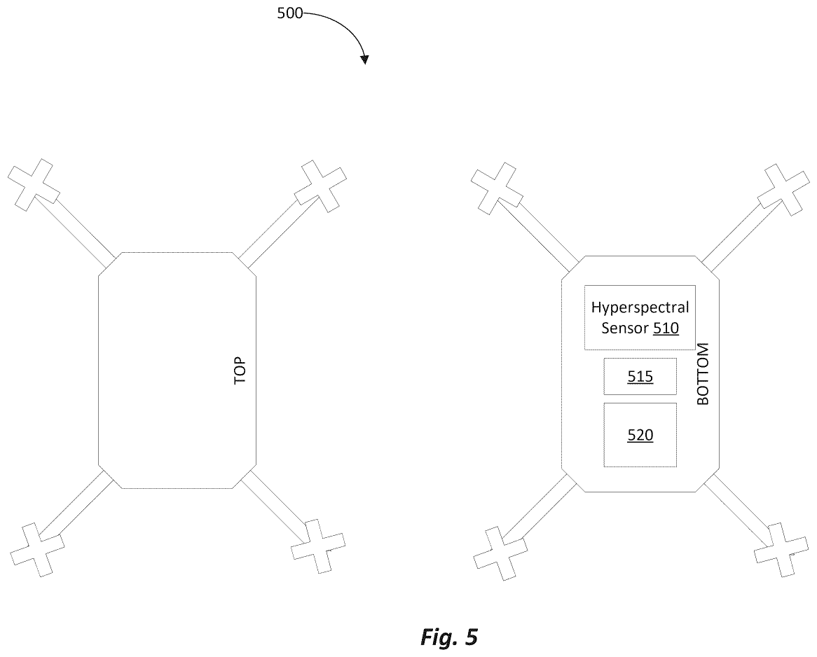

FIG. 5 illustrates a device included in a UAV 500 according to some embodiments. The UAV 500 can have a top surface and a bottom surface. In some implementations, sensor hardware, lighting, etc., can be installed on a bottom surface of the UAV 500, although it will be appreciated that other configurations are possible. The UAV 500 can include a hyperspectral sensor 510, light source 515, and one or more environmental sensors 520. In some embodiments, the light source 515 can be disposed near (e.g., adjacent to) the hyperspectral sensor 510. In some embodiments, the light source 515 can comprise a plurality of lighting sources that can be distributed along one or more edges of the bottom surface of the UAV 500. Other light sensors can be provided additionally or alternatively, such as RGB sensors or multispectral sensors.

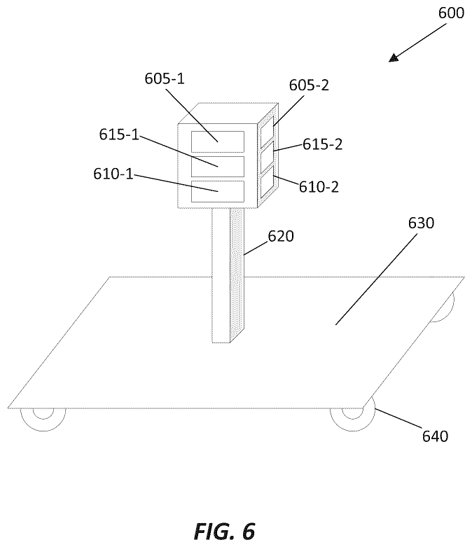

FIG. 6 illustrates a movable scanning device according to some embodiments. The movable scanning device 600 can include a base 630 that is mounted on movable members 640. The movable members 640 can be, for example, wheels, treads, etc. Sensing and related hardware can be mounted on a post 620. In some embodiments, the post 620 is fixed. In some embodiments, post 620 is a telescoping post. In some embodiments, the post 620 is a rotatable post. In some embodiments, the movable scanning device 600 can include one or more motors, actuators, etc., and control hardware for extending, retracting, and/or rotating the post 620. The movable scanning device 600 can include sensors (e.g., hyperspectral sensors) 605 on one or more sides (605-1 and 605-2 in FIG. 6). The movable scanning device 600 can include environmental sensors 610 (610-1 and 610-2 in FIG. 6) on one or more sides. The movable scanning device 600 can include light sources 615 on one or more sides (615-1 and 615-2 in FIG. 6). In some embodiments, rather than or in addition to having multiple sensors, environmental sensors, light sources, etc., the movable scanning device 600 is configured to rotate at least a single sensor 605 such that scans can be performed over a large area with only a single sensor.

While several example devices have been illustrated, it will be appreciated that the approaches described herein can be used with a variety of hardware configurations, such as fixed benchtop setups, portable scanning devices that attach to or interface with a smartphone, tablet, or other computing device, fixed equipment installed in a production line (e.g., as part of a food or drug inspection station), and so forth.

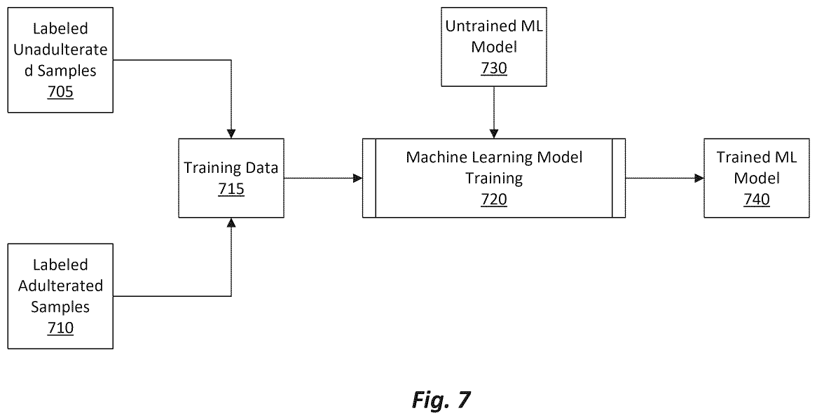

FIG. 7 is a block diagram that illustrates an example of machine learning model training according to some embodiments. As shown in FIG. 7, a system can be configured to use labeled unadulterated samples 705 (e.g., samples where a target is not present) and labeled adulterated samples 710 (e.g., where the target is present) to create training data 715. Samples can be labeled in various ways. For example, in some embodiments, different models can be used for different targets, and the labels can indicate whether a target is present or not. In some embodiments, a single model can be used for multiple targets, and the labels can indicate which target or targets are present in the samples. In some embodiments, the samples can include hyperspectral data. In some embodiments, the samples can include information indicating a substrate, such as agar, skin, metal, wood, plant matter, etc. In some embodiments, the samples can include environmental information, such as temperature, humidity, ambient lighting conditions, and so forth. Such detailed information can be important because it can be desirable for a machine learning model to be able to detect targets under a variety of imaging conditions and on a variety of surfaces or using a variety of sample collection methods. A machine learning model training process 720 can use the training data 715 to train an untrained machine learning model to create a trained machine learning model 740. In some embodiments, the untrained machine learning model 730 can be a prior version of a model (e.g., the untrained machine learning model 730 may be a machine learning model that was previously trained, and the trained machine learning model 740 can be an updated version of the previously-trained model). The machine learning model training 720 can include adjusting one or more weights of the untrained machine learning model 730. Weights can be adjusted in an iterative manner so that the machine learning model learns to identify targets. In some embodiments, the machine learning model training 720 uses supervised learning.

FIG. 8A illustrates a functional block diagram of a progressive, multi-level acquisition pipeline according to some embodiments. The process can begin (800) by defining a task and operational constraints (e.g., target class, time/energy budget, safety limits). For Level 1, for example, the system can configure an acquisition profile (M₁, B₁, L₁, R₁) including one or more sensing modalities M₁ (e.g., visible, thermal, hyperspectral subsets), a band set B₁ (number/spacing of bands), illumination L₁ (e.g., broadband or line sources), and spatial/spectral resolution R₁. The system captures Level-1 data (801) and extracts features (802). A stopping criterion (803) is then evaluated. If satisfied, data collected up to the current level are fused (804) and used for detection/output (810). If not satisfied, the pipeline escalates to Level 2 with a new configuration (M₂, B₂, L₂, R₂) and repeats capture (805), feature extraction (806), and stopping evaluation (807). The escalation can continue for any number of levels (Level n) until a stopping criterion is met. For example, if the stopping evaluation is not satisfied, the process can proceed to a detailed scan (808) and analysis of the detailed scan (809). Upon stopping, the system performs fusion of data from the performed levels (feature-level and/or decision-level) (804) and produces the detection/report (810). The number of levels, their ordering, and their configurations are application-dependent and non-limiting; examples include (i) visible bands first, then thermal plus selected hyperspectral bands, and finally full HSI/NIR; or (ii) progressively denser HSI band grids.

FIG. 8B illustrates the core escalation and fusion workflow of the progressive multi-level acquisition system according to some embodiments. The diagram shows that at each acquisition level, the system follows a repeating cycle: (1) configure parameter for level (811) (2) acquire and analyze data at the current level (812, 813), (3) evaluate whether the collected information is sufficient for reliable detection (814), and (4) make a decision. If the evaluation indicates sufficient information, the system halts acquisition and proceeds to fuse all collected data across the completed levels for detection (816, 817) and generate a final decision/report (818). If information is deemed insufficient, the system escalates to the next level (815) and repeats the cycle with a potentially refined acquisition configuration. This adaptive escalation allows the system to collect only the data necessary for confident detection, thus optimizing resource usage and detection latency.

FIG. 8C provides a more detailed flow for progressive multi-level acquisition according to some embodiments. FIG. 8C depicts escalation thresholds and fusion policy for a progressive pipeline with an arbitrary number K≥2 of levels. Within a generic Level k, the system sets the acquisition configuration (Mₖ, Bₖ, Lₖ, Rₖ) (819), captures data (820), and computes a corresponding feature set (821). The system then evaluates a policy πₖ or threshold τₖ to determine whether sufficient information has been obtained to stop or whether to escalate to Level k+1 (822). Non-limiting examples of πₖ include achieving at least a specified reduction in uncertainty, meeting an information-gain target, or exceeding an anomaly/ROI score. If the stop condition is met at level k, the system performs feature-level fusion μ_{fuse} (L₁ . . . Lₖ) (e.g., a learned projection, attention-based combining, concatenation followed by normalization) (824) and optionally decision-level fusion

$${ψ}_{fuse} ( {\{ {p}_{ℓ} \}}_{ℓ = 1}^{k} )$$

(e.g., learned weights, stacking, Bayesian aggregation of per-level decisions) (825), and then outputs a final decision/report (826). Otherwise, the pipeline escalates to the next level (823) and repeats. The fusion blocks are generic and not limited to any particular algorithm; they may be differentiable mappings trained end-to-end or non-differentiable post-processing routines, depending on the embodiment.

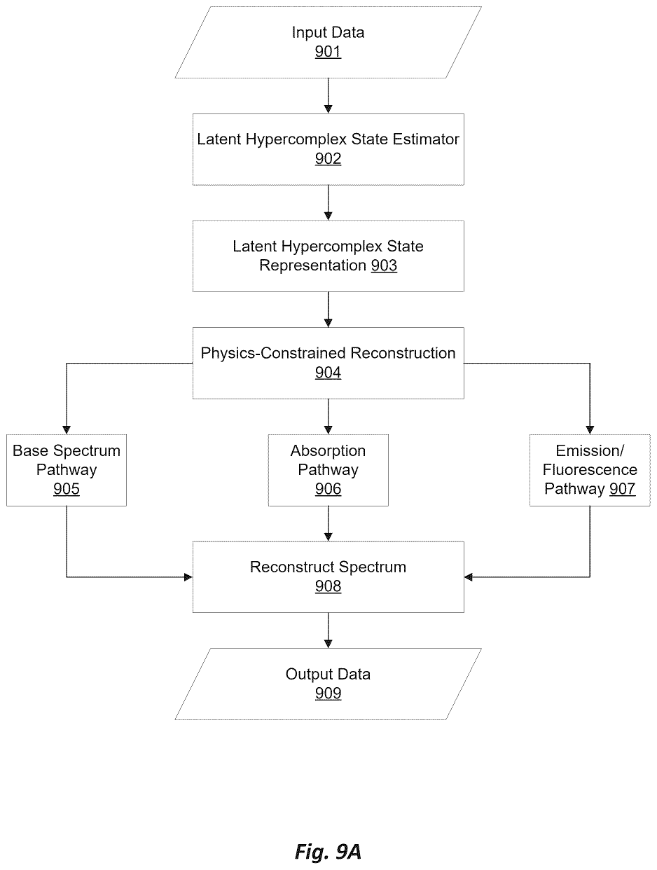

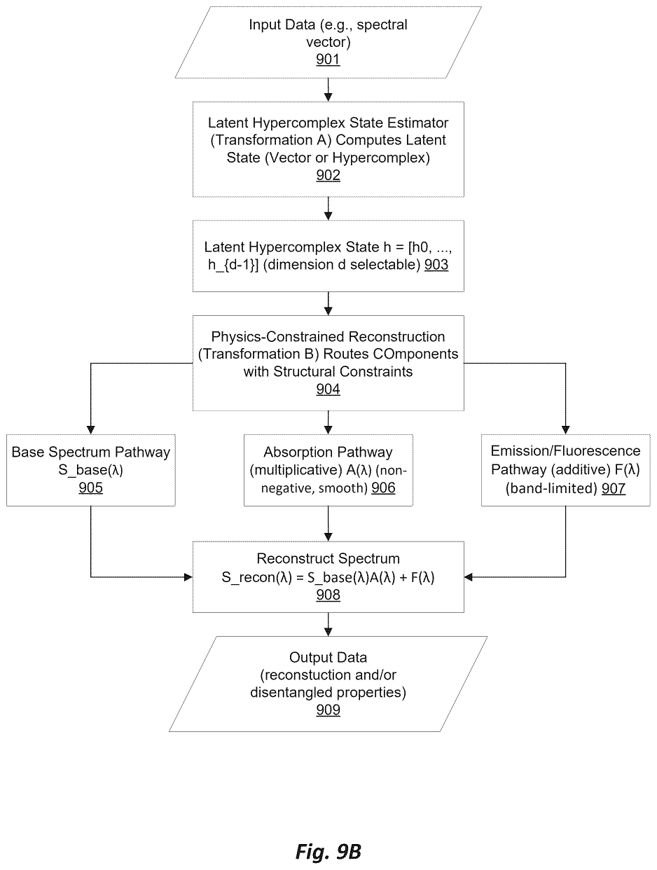

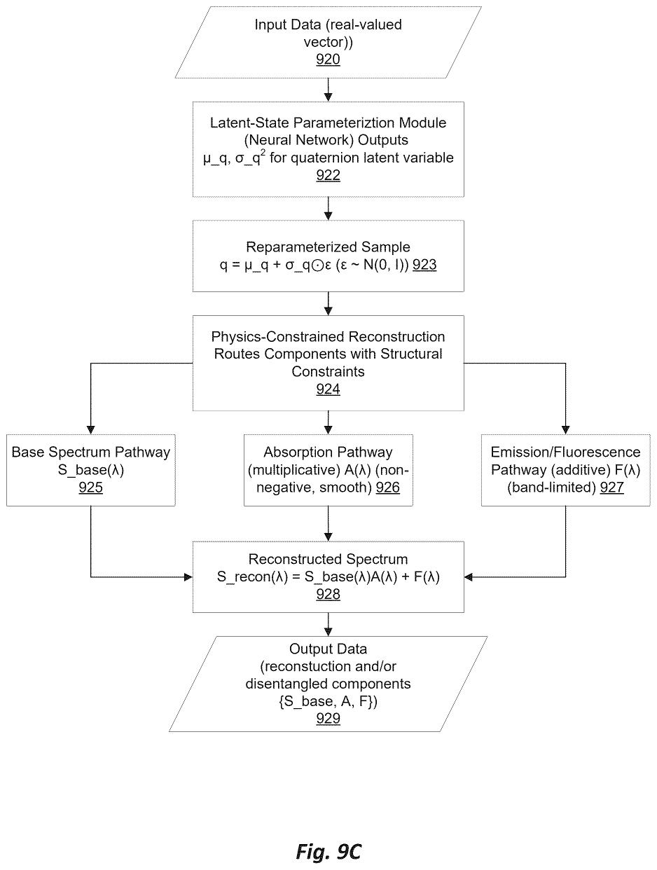

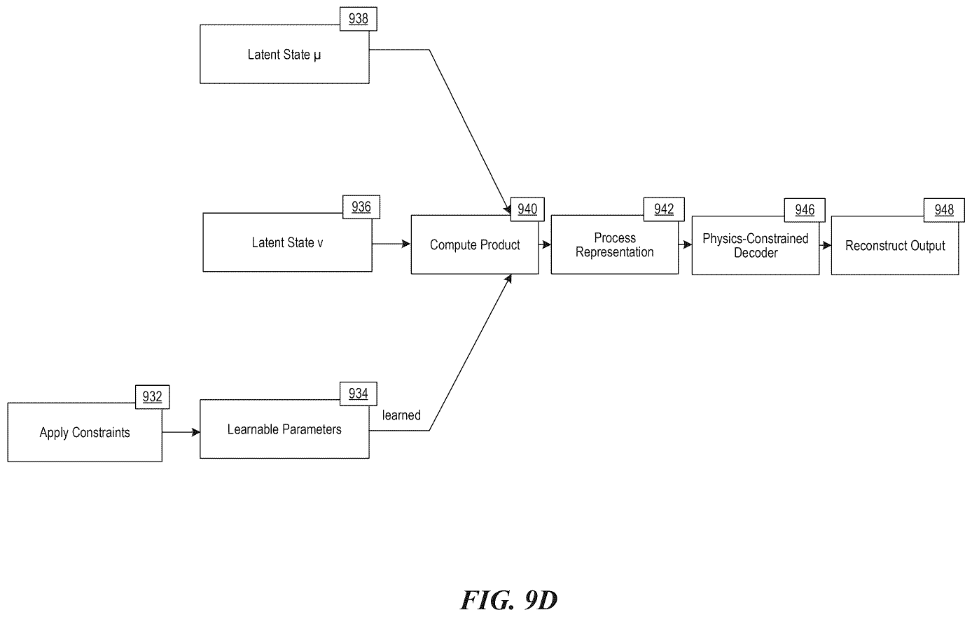

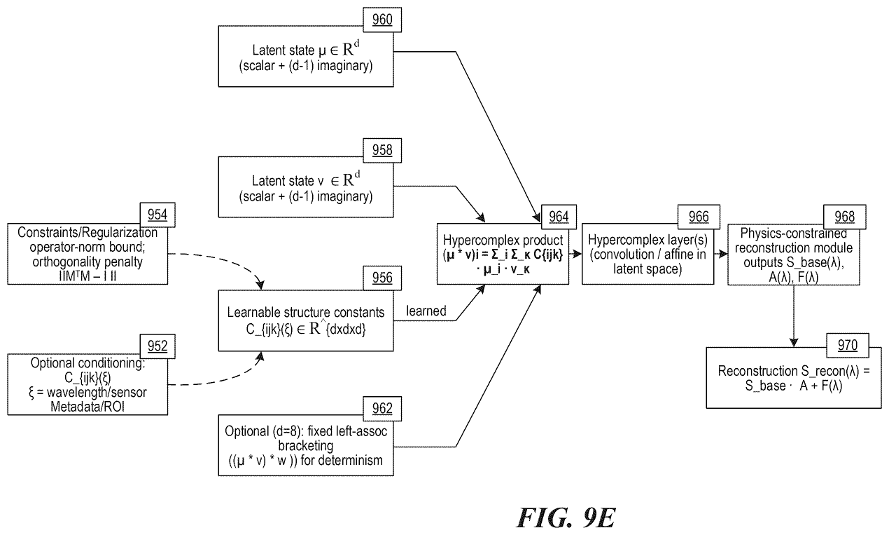

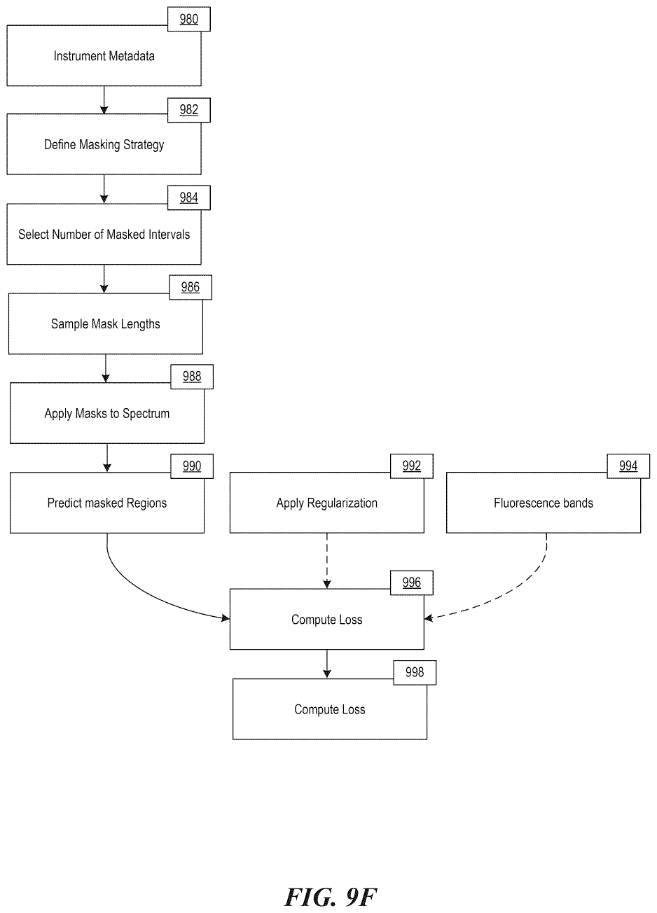

FIG. 9A is a flowchart that illustrates a physics-constrained reconstruction architecture according to some implementations. The architecture consists of three main components: a latent-state estimator (902) that encodes input spectra (901) into a latent representation (903), a physics-constrained reconstruction module (904) that decodes the latent representation, and three constrained pathways (base spectrum pathway 905, absorption pathway 906, and emission/fluorescence pathway 907) that produce distinct spectral components. This conceptual design separates the learning of the latent representation from the physical constraints imposed on the reconstruction, enabling the system to disentangle different physical properties (e.g., illumination, material composition, fluorescence) into interpretable, physically meaningful components. The architecture is dimension-agnostic; the latent representation can be a real vector (standard neural network) or a hypercomplex manifold of selectable dimension. The outputs from the individual pathways can be used to reconstruct a spectrum (908), from which output data (909) can be generated.

FIG. 9B is a diagram that illustrates using a generative model with a physics-constrained reconstruction module for disentanglement of physical properties. A latent-state estimator (902) maps the input spectrum (901) to a latent state (903) (which may be a real vector or a hypercomplex state of selectable dimension). The reconstruction module (904) routes different latent components through structurally constrained pathways (905, 906, 907) to produce a base spectrum S_{base}(λ), a multiplicative absorption profile A(λ) (non-negative and spectrally smooth), and an additive fluorescence/emission profile F(λ) (band-limited). The reconstructed spectrum follows S_{recon}(λ)=S_{base}(λ)·A(λ)+F(λ) (908). Additional pathways (e.g., scattering or substrate terms) may be included as needed. When a hypercomplex latent is used, learnable structure constants Cᵢⱼₖ defining multiplication are described in FIG. 9C. The reconstructed spectrum can be used to produce output data 909, which can include the reconstruction and/or disentangled properties in some embodiments.

FIG. 9C is a diagram that shows an example implementation using a quaternion latent variable. A latent-state parameterization module (922) produces mean and variance parameters

$${μ}_{q} , {σ}_{q}^{2}$$

for a quaternion q (920); a reparameterized sample q=μ_{q}+σ_{q}⊙ε (with ε˜ [symbol] (0, I)) (923) is drawn. A physics-constrained reconstruction module (924) routes quaternion components to structurally constrained pathways: the scalar w together with an imaginary component x yields a base spectrum S_{base}(λ) (925); component y yields a non-negative, spectrally smooth absorption profile A(λ) (926); component z yields a band-limited fluorescence/emission profile F(λ) (927). The reconstructed spectrum (928) follows S_{recon}(λ)=S_{base}(λ)·A(λ)+F(λ). Output data, such as the reconstruction and/or disentangled components can be provided (929). This quaternion example is illustrative and non-limiting; other embodiments may use latent hypercomplex states of different dimension with learnable structure constants, as described herein.

FIG. 9D depicts a hypercomplex latent-space architecture for defining learnable multiplication operations in latent space according to some embodiments. Rather than using a fixed algebra (such as standard quaternions), the architecture learns the algebraic structure through trainable parameters called structure constants. That is, learned parameters (934) can be learned within the context of constraints (932). Two latent vectors (926, 938) are combined (940) using this learned hypercomplex product, generating intermediate features that are processed through subsequent layers (942). The learned latent representation is then passed to a physics-constrained reconstruction module (946), which can produce base spectrum, multiplicative absorption profile, and/or additive fluorescence components. A system can reconstruct an output (948) using one more of the base spectrum, multiplicative absorption profile, or additive fluorescence components. This approach generalizes fixed algebraic systems to arbitrary dimensions with task-specific algebras, allowing the system to learn the optimal latent-space geometry for spectrum disentanglement.

FIG. 9E is a block diagram of a hypercomplex latent-space architecture in which multiplication among latent components is defined by learnable structure constants Cᵢⱼₖ. Two latent vectors u, v∈ [symbol] (958, 960) (each comprising a scalar channel and d−1 imaginary channels) are combined by a trainable hypercomplex product (u*v)ᵢ=Σ_{j,k}Cᵢⱼₖuⱼvₖ (964). One or more hypercomplex layers (966) (affine or convolutional) use this product to compute intermediate features that are provided to a physics-constrained reconstruction module (968), which can output a base spectrum S_{base}(λ), a multiplicative absorption profile A(λ) (constrained non-negative and smooth), and an additive fluorescence profile F(λ) (constrained band-limited). A reconstructed spectrum (978) is then formed as S_{recon}(λ)=S_{base}(λ)·A(λ)+F(λ). Training can regularize Cᵢⱼₖ (956) with operator-norm control and orthogonality-deviation penalties or other conditioning (952, 954); associative (e.g., quaternionic) and non-associative (e.g., octonion-like, with fixed bracketing) embodiments are supported. Fixed-left association bracketing (962) can be used for determinism in some embodiments.

FIG. 9F illustrates a masked-wavelength pretraining strategy for self-supervised learning of the reconstruction architecture according to some embodiments.

The strategy leverages instrument metadata (e.g., spectral spacing AA, FWHM) (980) to define a distribution of mask lengths calibrated to the spectrometer's characteristics, and a number of mask intervals can be selected (982, 984, 986). During training, contiguous spectral intervals can be randomly masked (988) in input spectra, and the model learns to reconstruct the masked regions from unmasked context (990). The training objective can incorporate reconstruction accuracy along with physics-inspired regularization terms that constrain the absorption and/or fluorescence components to be physically plausible (smooth absorption, band-limited fluorescence). This domain-aware pretraining can enable the model to learn meaningful spectral decomposition without labeled data, bootstrapping the system for downstream detection tasks. Losses can be computed (996, 998) and regularization (992) can be applied. In some embodiments, fluorescence bands (994) are used in the loss computation.

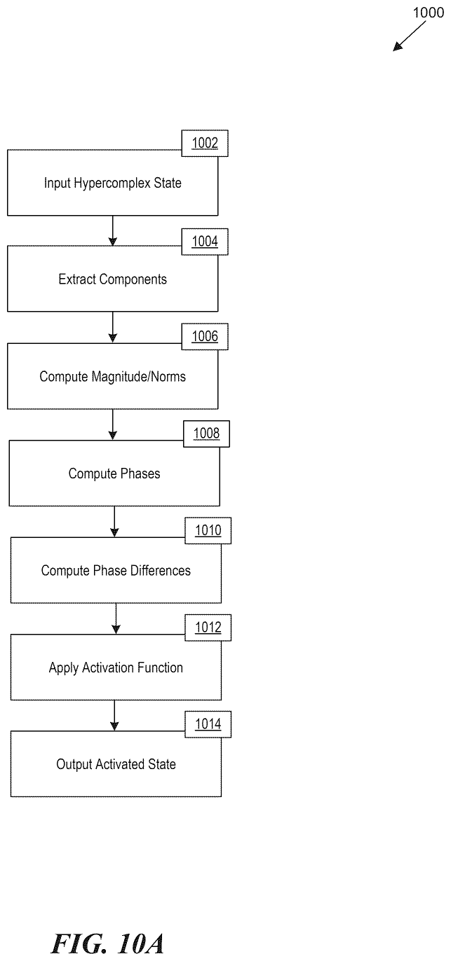

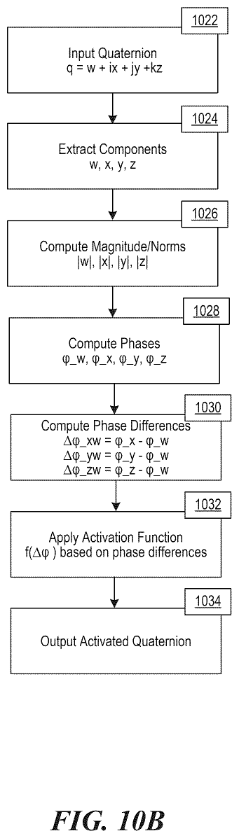

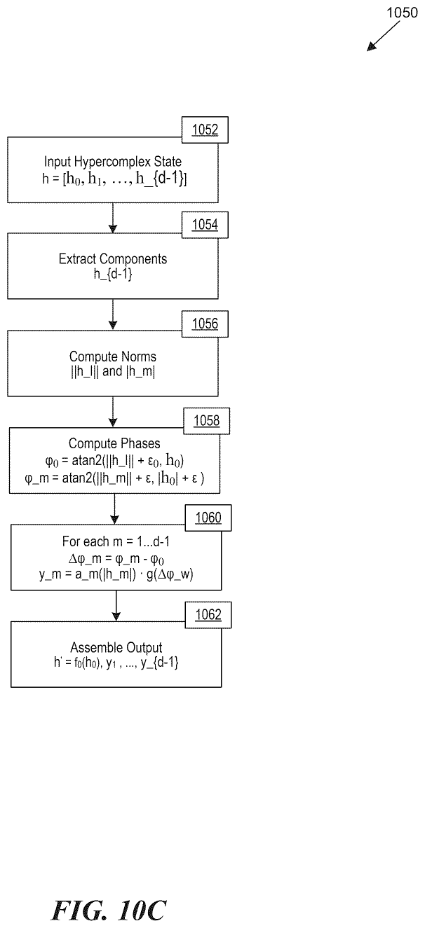

FIG. 10A illustrates a high-level overview of hypercomplex phase-difference activation, a novel nonlinear activation function designed for hypercomplex latent representations. The activation mechanism operates by extracting components (1004) from the input hypercomplex state (1002), computing the magnitude and phase of each component (1006, 1008), and forming phase differences relative to a reference phase (typically the real channel) (1010). These phase differences can be passed through a bounded nonlinearity, optionally modulated by amplitude-shaping functions, to produce the activated output (1012). This activation can exploit the rich geometric structure of hypercomplex numbers by capturing inter-component phase relations that are not present in standard real-valued or complex-valued activations. The result(s) can be used to output the activated state (1014). This approach is dimension-agnostic; the same principle applies to complex numbers (d=2), quaternions (d=4), octonions (d=8), and arbitrary dimensions. Specific instantiations for quaternions and general d-dimensional hypercomplex states are provided in FIGS. 10B and 10C, respectively.

FIG. 10B illustrates a quaternion-specific phase-difference activation, according to some embodiments. An input quaternion q=w+ix+jy+kz (1022) is decomposed into components w, x, y, z (1024). Per-component magnitudes |w|, |x|, |y|, |z| (1026) and phases φ_{w}, φₓ, φ_{y}, φ_{z} (1028) can be computed, and phase deltas can formed relative to the real channel (1030), e.g., Δφ_{xw}=φₓ−φ_{w}, Δφ_{yw}=φ_{y}−φ_{w}, Δφ_{zw}=φ_{z}−φ_{w}. A bounded nonlinearity g(·) (e.g., tanh) can be applied to each delta (1032), optionally modulated by an amplitude-shaping function aₘ (|·|), while the real channel is passed through a scalar function ƒ₀(·). The output (1034) is an “activated” quaternion q′=[f₀(w), aₓ(|x|)g(Δφ_{xw}), a_{y}(|y|)g(Δφ_{yw}), a_{z}(|z|)g(Δφ_{zw})]. This activation exploits inter-component phase relations unique to quaternions, enabling dependencies that are not captured by real-valued activations.

FIG. 10C illustrates a dimension-agnostic hypercomplex phase-difference activation that generalizes the quaternion case to a d-component latent state h=[h₀, h₁, . . . , h_{d-1}] with scalar channel h₀ and d−1 imaginary channels according to some embodiments. A system can extract components (1054) from an input hypercomplex state (1052), and can compute norms (1056). The activation computes a reference phase φ₀=atan 2(∥hᵢ∥+ε, h₀), where h_{I}=[h₁, . . . , h_{d-1}], and per-component phases φₘ=atan 2(|hₘ|+ε, |h₀|+ε) for m=1, . . . , d−1 (1058). For each imaginary component, a phase delta Δφₘ=φₘ−φ₀ is mapped by a bounded nonlinearity g and amplitude shaper aₘ to produce yₘ=aₘ(|hₘ|)g(Δφₘ) (1060). The scalar channel passes through f₀, yielding h′=[f₀(h₀), y₁, . . . , y_{d-1}] (1062). This formulation applies unchanged to complex (d=2), quaternionic (d=4), and octonion-style (d=8) embodiments and is compatible with learnable hypercomplex multiplication defined by structure constants Cᵢⱼₖ.

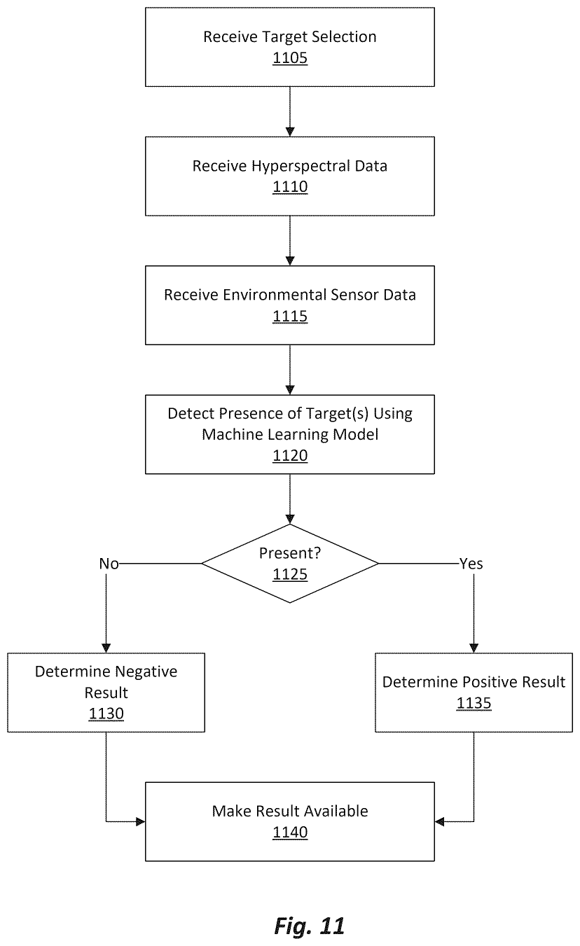

FIG. 11 is a flowchart that illustrates an example target detection process according to some embodiments. At operation 1105, a system can receive a target selection. The target selection can be for a single target or for multiple targets. The target selection can be used to identify wavelengths at which data is to be collected. In some embodiments, a user may not select a target, and the system can scan over a range of wavelengths to identify possible targets. In some embodiments, the system can, additionally or alternatively, receive a substrate selection. For example, a user can indicate that they are scanning skin, metal, etc. At operation 1110, the system can receive hyperspectral data, for example in response to the system triggering the collection of hyperspectral data. At operation 1115, the system can receive environmental sensor data, such as temperature, humidity, moisture content, and so forth. At operation 1120, the system can provide the received data to a machine learning model to detect the presence of the target. At operation 1125, if the target is not present, the system can determine a negative result at operation 1130. If, at operation 1125, the target is present, the system can determine a positive result at operation 1135. At operation 1140, the system can make the result available. For example, the system can display the result on a display, store the result in a database, etc.

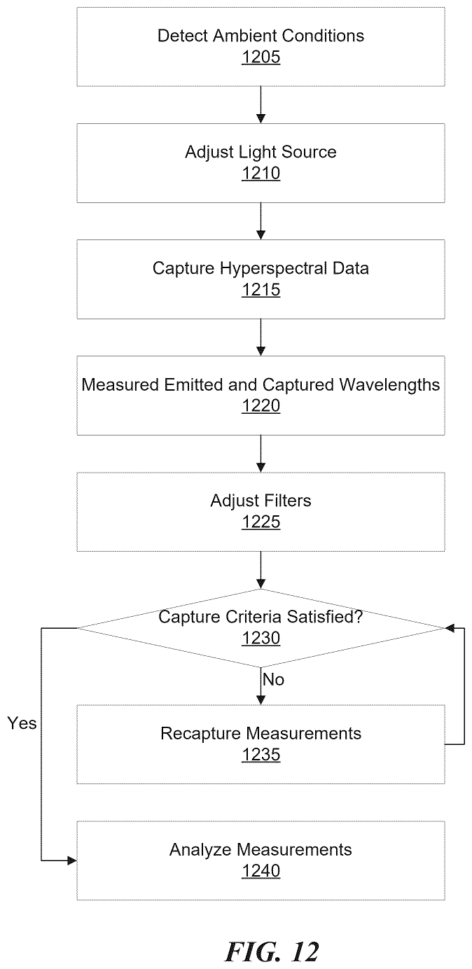

FIG. 12 is a flowchart that illustrates an example capture process according to some embodiments. The process depicted in FIG. 12 can be carried out fully or partially on a capture device. At operation 1205, the device can detect ambient conditions using one or more sensors (e.g., light sensors, humidity sensors, etc.). At operation 1210, the device can adjust a lighting source based at least in part on the detected ambient conditions. At operation 1215, the device can capture hyperspectral or other imaging data. At operation 1220, the device can measure emitted and captured wavelengths (e.g., intensity). The captured light can be light that is reflected off of and/or transmitted through a sample, surface, etc. At operation 1225, the device can adjust one or more filters. At operation 1230, the device can determine if one or more capture criteria are satisfied. If not, the device can recapture measurement data at operation 1235. If so, the device can analyze the measurements at operation 1240. In some embodiments, some parts of the process shown in FIG. 12 are carried out by other devices. For example, in some embodiments, analysis operations can occur on an external device such as a computer system.

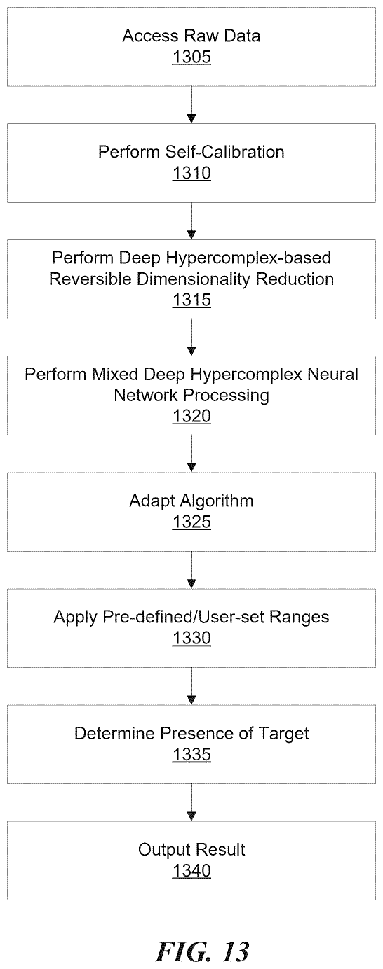

FIG. 13 is a flowchart that illustrates an example AI/ML processing pipeline according to some embodiments. At operation 1305, a system can access raw data (e.g., raw imaging data, raw hyperspectral data). The raw data can be completely unprocessed or may have undergone some processing, such as processing that is automatically performed when an image or hyperspectral scan is captured. At operation 1310, the system can perform a self-calibration, for example as described herein. At operation 1315, the system can perform PCA or other dimensionality reduction. At operation 1320, the system can perform hypercomplex processing. At operation 1325, the system can adapt an AI/ML algorithm, for example as described means. At operation 1330, the system can apply a pre-defined or user-set range to the data. At operation 1335, the system can determine a result indicating a presence or absence of a target substance. At operation 1340, the system can output the result. For example, the system can output the result to a display, which may be built into the system or separate from the system. In some embodiments, the output is a file, database record, or data element that can be stored in a non-volatile memory.

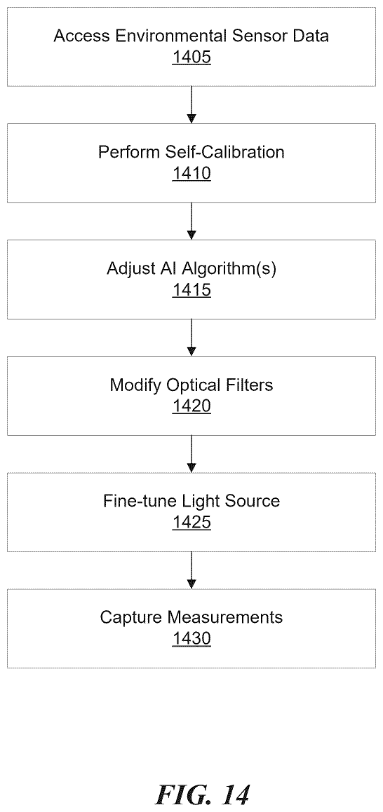

FIG. 14 is a flowchart that illustrates an example calibration and adaptation process according to some embodiments. At operation 1405, a system can access environment sensor data collected by one or more environmental sensors. At operation 1410, the system can perform a self-calibration. At operation 1415, the system can adjust one or more machine learning models. At operation 1420, the system can adjust or modify one or more optical filters, for example based at least in part on the environmental sensor data and/or the self-calibration. At operation 1425, the system can fine tune a light source, for example based on the environmental sensor data. At operation 1430, the system can capture measurements (e.g., a hyperspectral scan, an RGB image, etc.).

### EXAMPLES

Embodiment 1. A system for spectroscopic analysis of a target area to detect a target substance, comprising: a multi-modal sensor suite configured to acquire sensor data from the target area, wherein the sensor suite includes at least a hyperspectral sensor and a visible-spectrum sensor; and a processor configured to execute a physics-constrained computational model that processes the sensor data to generate a disentangled representation of physical properties of the target area, wherein the disentangled representation is a latent hypercomplex state having a scalar component and one or more imaginary components, and wherein the physics-constrained computational model utilizes a learnable hypercomplex algebra for operations in the latent hypercomplex state, and wherein the learnable hypercomplex algebra is parameterized by trainable structure constants defining multiplication among components of the latent hypercomplex state.

Embodiment 2. The system of embodiment 1, wherein the multi-modal sensor suite further comprises at least one of a thermal sensor and a near-infrared sensor.

Embodiment 3. The system of embodiment 1, wherein the processor is further configured to perform multi-level sensing by: conducting a first-level scan using a low-resolution sensor to identify regions of interest; and conducting a second-level scan using the hyperspectral sensor on the identified regions of interest.

Embodiment 4. The system of embodiment 3, wherein the multi-level sensing further comprises a third-level scan using a high-resolution sensor combined with fluorescent lighting on the regions of interest.

Embodiment 5. The system of embodiment 1, wherein the physics-constrained computational model comprises a spectral disentanglement module configured to map a real-valued spectral vector to the latent hypercomplex state and a physics-constrained reconstruction module configured to compute (i) a base reflectance spectrum, (ii) a multiplicative absorption profile, and (iii) an additive fluorescence profile from respective components of the latent hypercomplex state and to reconstruct a spectrum therefrom.

Embodiment 6. The system of embodiment 5, wherein the physics-constrained reconstruction module enforces structural constraints modeling physical interactions, wherein a scalar component of the latent hypercomplex state is processed through a multiplicative pathway representing absorption, and at least one imaginary component of the latent hypercomplex state is processed through an additive pathway representing fluorescence.

Embodiment 7. The system of embodiment 1, wherein the learnable hypercomplex algebra is defined by trainable structure constants that parameterize multiplication among components of the latent hypercomplex state, the structure constants being learned during training.

Embodiment 8. The system of embodiment 7, wherein the trainable structure constants are constrained during training by at least one of: bounded ranges, normalization, orthogonality, bounded operator norm, or sparsity.

Embodiment 9. The system of embodiment 1, wherein the physics-constrained computational model utilizes a hypercomplex activation that applies a phase-difference activation computed between at least one imaginary component and the scalar component of an input hypercomplex state to model interdependencies.

Embodiment 10. The system of embodiment 1, wherein the processor is further configured to train the physics-constrained computational model using a two-stage parameter-estimation regimen comprising: a masked-wavelength reconstruction subnetwork that predicts omitted contiguous spectral intervals while enforcing non-negativity and spectral smoothness of an attenuation profile and band-limited support of an emission profile; and physics-constrained fine-tuning in which a generative disentanglement module computes a base reflectance spectrum, a multiplicative absorption profile, and an additive fluorescence profile from components of the latent hypercomplex state and reconstructs a spectrum, while concurrently optimizing parameters of a learnable hypercomplex multiplication operator under one or more regularizers including normalization, orthogonality, sparsity, and bounded operator norm.

Embodiment 11. The system of embodiment 1, wherein the system is embodied in an unmanned aerial vehicle (UAV) configured to scan the target area autonomously.

Embodiment 12. The system of embodiment 1, wherein the system is embodied in a handheld device configured to display detection results in real time.

Embodiment 13. The system of embodiment 1, wherein the processor is further configured to perform real-time edge processing of the sensor data to enable on-device analysis without transmitting raw data to an external server.

Embodiment 14. The system of embodiment 1, wherein the system is further configured to integrate with an external computing device by wireless communication to transmit processed results or receive control inputs.

Embodiment 15. A computer-implemented method for spectroscopic detection of a target in a scene, comprising: acquiring scene data at a plurality of progressively escalated scanning levels comprising at least two levels; at each scanning level of the plurality of scanning levels, evaluating a stopping policy or threshold prior to escalation; fusing data the scene data; and outputting a detection decision for the target based on the fused data.

Embodiment 16. The method of embodiment 15, wherein the progressively escalated scanning levels comprise: a first level using broadband lighting with a visible-spectrum sensor and near-infrared sensor to identify regions of interest; a second level using ultraviolet sensing and shortwave-infrared sensing and selected hyperspectral bands to analyze the regions of interest; and a third level using full hyperspectral sensing and fluorescence sensing.

Embodiment 17. The method of embodiment 15, wherein fusing comprises feature-level fusion of spectral descriptors, spatial texture metrics, and thermal gradients, followed by a classifier trained to detect a target.

Embodiment 18. A computer-implemented method of reconstructing and analyzing spectra, comprising: computing, from a real-valued spectral vector, a latent hypercomplex state; applying a physics-constrained reconstruction that computes, from respective components of the latent hypercomplex state, physically interpretable terms including at least (i) a multiplicative attenuation term constrained to be non-negative and spectrally smooth and (ii) an additive emission term constrained to be band-limited, wherein a spectrum is reconstructed based on the terms; and classifying a target using at least one of the reconstructed spectrum, an absorption profile, or a fluorescence profile.

Embodiment 19. The method of embodiment 18, wherein reconstructing the spectrum comprises computing a reconstructed spectrum equal to a product of the base spectrum and the absorption profile plus the fluorescence profile and wherein the physics-constrained reconstruction constrains the attenuation profile to be non-negative and smoothly varying across wavelength and constrains the emission profile to be additive and band-limited.

Embodiment 20. The method of embodiment 18, wherein at least one operation in computing the latent hypercomplex state or in the physics-constrained reconstruction employs hypercomplex convolution over grouped spectral bands using a learnable hypercomplex algebra.

Embodiment 21. The method of embodiment 18, wherein at least one layer applies a phase-difference hypercomplex activation computed between at least one imaginary component and a scalar component of the latent hypercomplex state.

Embodiment 22. A non-transitory computer-readable medium storing instructions that, when executed by one or more processors, cause the processors to: pre-train a spectral reconstruction subnetwork by masking contiguous wavelength intervals of an input spectrum and predicting the masked intervals from unmasked portions subject to physics regularizers that enforce (i) non-negativity and spectral smoothness of an attenuation vector and (ii) band-limited support of an emission profile; and fine-tune the subnetwork jointly with a physics-constrained reconstruction module that, from a latent hypercomplex state, computes (i) a base reflectance spectrum, (ii) a multiplicative absorption profile constrained to be non-negative, and (iii) an additive fluorescence profile constrained to be band-limited, and reconstructs a spectrum; and update parameters of a learnable hypercomplex multiplication operator used in latent-space operations, the operator being constrained to maintain a bounded operator norm during training.

Embodiment 23. The non-transitory computer-readable medium of embodiment 22, wherein masking comprises selecting contiguous wavelength intervals whose band length is drawn from a probability distribution calibrated to instrument spectral band spacing.

Embodiment 24. The non-transitory computer-readable medium of embodiment 22, wherein a training loss function includes (i) a norm of a spectral derivative of the attenuation profile to promote smoothness, and (ii) a penalty that drives the emission profile toward zero outside predefined emission bands.

Embodiment 25. The non-transitory computer-readable medium of embodiment 22, wherein the learnable hypercomplex multiplication operator is regularized toward orthogonality by minimizing a deviation measure during training.

Embodiment 26. The non-transitory computer-readable medium of embodiment 22, wherein the instructions further cause the processors to control progressive multi-level acquisition comprising: performing a first level using broadband lighting with a visible-spectrum sensor to identify regions of interest; performing a second level using thermal sensing and selected hyperspectral bands to analyze the regions of interest; performing a third level using full hyperspectral sensing and near-infrared microscopy; fusing data from the performed levels; and generating a detection decision for a target based on the fused data.

Embodiment 27. The non-transitory computer-readable medium of embodiment 22, wherein the instructions further cause the processors to apply a hypercomplex phase-difference activation by computing phase differences between at least one imaginary component and a scalar component of a hypercomplex input state, applying an activation function of the phase differences to produce an activated state, and supplying the activated state to a subsequent layer.

Embodiment 28. The non-transitory computer-readable medium of embodiment 22, wherein the input spectrum is acquired by a multi-modal sensor suite comprising at least a hyperspectral sensor and a visible-spectrum sensor during progressive scanning.

Embodiment 29. A system comprising: one or more processors; and memory storing instructions that, when executed, cause the processors to perform hypercomplex convolution over grouped spectral bands using a learnable hypercomplex algebra defined by a tensor of trainable structure constants that parameterize multiplication among components of a latent state, the constants being optimized during training to improve separation of base material spectra from target-substance signatures, independent of specific model architectures.

Embodiment 30. The system of embodiment 29, wherein the learnable hypercomplex algebra is represented by a third-order parameter tensor of structure constants of size D×D×D, where D denotes a dimension of the algebra, the tensor being constrained by at least one of orthogonality, normalization, bounded magnitude, bounded operator norm, or sparsity.

Embodiment 31. A movable scanning device comprising: at least one hyperspectral sensor, at least one environmental sensor, at least one programmable light source, and a drive configured to move or rotate the sensor to scan an extended area; the device being configured to escalate from a coarse visible-light scan to fine hyperspectral analysis of identified regions of interest.

Embodiment 32. The movable scanning device of embodiment 31, embodied as a drone, robot, handheld unit, mounted system, or mobile-device accessory, and including a communications interface for wired or wireless data exchange.

Embodiment 33. The system of embodiment 1, wherein the processor adjusts illumination intensity, wavelength bands, or exposure for a subsequent scan based on the disentangled representation.

Embodiment 34. The method of embodiment 18, wherein the real-valued spectral vector is acquired by a multi-modal sensor suite comprising at least a hyperspectral sensor and a visible-spectrum sensor.

Embodiment 35. The system of embodiment 1, wherein the latent hypercomplex state has dimension two (complex).

Embodiment 36. The system of embodiment 1, wherein the latent hypercomplex state has dimension four (quaternionic) and the learnable hypercomplex algebra reduces to Hamilton multiplication when the structure constants are set to quaternion values.

Embodiment 37. The system of embodiment 1, wherein the latent hypercomplex state has dimension eight (octonionic) and the learnable hypercomplex algebra admits non-associative multiplication specified by trainable structure constants.

Embodiment 38. The system of embodiment 1, wherein the learnable hypercomplex algebra is represented by a third-order parameter tensor of structure constants used to compute products of components of the latent hypercomplex state.

Embodiment 39. The method of embodiment 18, wherein the attenuation term models absorption and scattering as A_total(λ)=A_abs(λ)·A_scat(λ).

Embodiment 40. The method of embodiment 18, further comprising an additive scattering component H(λ) representing path radiance, and wherein reconstructing the spectrum comprises combining at least the attenuation term, the emission term, and H(λ).

Embodiment 41. The method of embodiment 18, wherein scattering is modeled as wavelength coupling via a kernel K(λ, λ′) applied to a baseline reflectance term R(λ′) such that reconstructing the spectrum includes an additional mixing term JK(λ, λ′) R(λ′) dλ′ (or a discrete summation counterpart over spectral bands).

Embodiment 42. A system for non-intrusive spectroscopic analysis of a target area to detect adulterants includes: a multi-modal sensor suite designed to gather data from the target area, comprising at least a hyperspectral sensor, a visible-spectrum sensor, and at least one thermal or near-infrared sensor; and a processor configured to run a physics-informed neural network that interprets the sensor data to generate a disentangled representation of physical properties of the target area, wherein the representation comprises a latent hypercomplex state with a scalar component and one or more imaginary components, and wherein the neural network employs a learnable hypercomplex algebra.

Embodiment 43. A system for non-intrusive spectroscopic analysis of a target area to detect adulterants, comprising: a multi-modal sensor suite designed to collect sensor data from the target area, including at least a hyperspectral sensor, a visible-spectrum sensor, and at least one of a thermal sensor or a near-infrared sensor; and a processor configured to: perform multi-layer sensing by conducting a first-level scan using a low-resolution sensor to identify regions of interest, conducting a second-level scan using the hyperspectral sensor on the identified regions of interest, and conducting a third-level scan using a high-resolution sensor combined with fluorescent lighting on the regions of interest; and run a physics-informed neural network that processes the sensor data to produce a disentangled representation of physical properties of the target area. adjust illumination intensity, wavelength bands, or exposure for a subsequent scan based on the disentangled representation to optimize detection of adulterants in the identified regions of interest.

Embodiment 44. A system for non-intrusive spectroscopic analysis of a target area to detect adulterants, comprising: a multi-modal sensor suite designed to collect sensor data from the target area, including at least a hyperspectral sensor and a visible-spectrum sensor; and a processor configured to run a physics-informed neural network that processes the sensor data to produce a disentangled representation of physical properties of the target area as a latent hypercomplex state, wherein the physics-informed neural network comprises: a spectral disentanglement module configured to map a real-valued spectral vector to the latent hypercomplex state using hypercomplex convolution over grouped spectral bands with a learnable hypercomplex algebra; and a physics-constrained reconstruction module configured to compute (i) a base reflectance spectrum, (ii) a multiplicative absorption profile, and (iii) an additive fluorescence profile from respective components of the latent hypercomplex state and to reconstruct a spectrum therefrom, wherein: the physics-constrained reconstruction module enforces structural constraints modeling physical interactions such that a scalar component of the latent hypercomplex state is processed through a multiplicative pathway representing absorption, and at least one imaginary component of the latent hypercomplex state is processed through an additive pathway representing fluorescence; and The absorption profile is constrained to be non-negative and smoothly varying across wavelength, and the fluorescence profile is constrained to be additive and band-limited.

Embodiment 45. A system for non-intrusive spectroscopic analysis of a target area to detect adulterants, comprising: a multi-modal sensor suite designed to collect sensor data from the target area, including at least a hyperspectral sensor and a visible-spectrum sensor; and a processor configured to run a physics-informed neural network that processes the sensor data using a learnable hypercomplex algebra defined by trainable structure constants that parameterize multiplication among components of a latent hypercomplex state, wherein: the structure constants are learned during training, the learnable hypercomplex algebra is represented by a third-order parameter tensor of structure constants used to compute products of components of the latent hypercomplex state, the trainable structure constants are constrained by at least one of: unconstrained optimization, bounded ranges, discrete values, or normalization, the physics-informed neural network utilizes a hypercomplex activation that computes phase differences between at least one imaginary component and a scalar component of an input hypercomplex state to model interdependencies, and at least one neural layer applies the hypercomplex activation as a phase-difference computation between an imaginary component and the scalar component of the latent hypercomplex state, wherein the latent hypercomplex state has a dimension selected from: (i) dimension two implementing complex algebra, (ii) dimension four implementing quaternionic algebra wherein the learnable hypercomplex algebra reduces to Hamilton multiplication when the structure constants are set to quaternion values, or (iii) dimension eight implementing octonionic algebra wherein the learnable hypercomplex algebra admits non-associative multiplication specified by trainable structure constants.

Embodiment 46. A system for non-intrusive spectroscopic analysis of a target area to detect adulterants, comprising: a multi-modal sensor suite designed to collect sensor data from the target area, including at least a hyperspectral sensor and a visible-spectrum sensor; and a processor configured to: run a physics-informed neural network that processes the sensor data to produce a disentangled representation of physical properties of the target area as a latent hypercomplex state using hypercomplex convolution over grouped spectral bands; and train the physics-informed neural network using a two-stage parameter-estimation regimen comprising: a masked-wavelength reconstruction subnetwork that predicts omitted contiguous spectral intervals while enforcing non-negativity and spectral smoothness of an attenuation profile and band-limited support of an emission profile; and physics-constrained fine-tuning in which a generative disentanglement module computes a base reflectance spectrum, a multiplicative absorption profile, and an additive fluorescence profile from components of the latent hypercomplex state and reconstructs a spectrum, wherein the absorption profile is constrained to be non-negative and smoothly varying across wavelength and the fluorescence profile is constrained to be additive and band-limited, while concurrently optimizing parameters of a learnable hypercomplex multiplication operator under normalization constraints.

Embodiment 47. A system for non-intrusive spectroscopic analysis of a target area to detect adulterants, comprising: a multi-modal sensor suite designed to collect sensor data from the target area, including at least a hyperspectral sensor and a visible-spectrum sensor; a processor configured to: run a physics-informed neural network that processes the sensor data to produce a disentangled representation of physical properties of the target area; and perform real-time edge processing of the sensor data to enable on-device analysis without transmitting raw data to an external server; and a wireless communication module configured to integrate with an external computing device to transmit processed results or receive control inputs.

Embodiment 48. A system for non-intrusive spectroscopic analysis of a target area to detect adulterants, comprising: a multi-modal sensor suite designed to collect sensor data from the target area, including at least a hyperspectral sensor and a visible-spectrum sensor; a processor configured to run a physics-informed neural network that processes the sensor data to produce a disentangled representation of physical properties of the target area; and a display; wherein the system is embodied in a handheld device configured to display detection results in real time.

Embodiment 49. A system for non-intrusive remote spectroscopic monitoring and analysis of a target area or large land, sea, and air regions to detect adulterants, comprising: a multi-modal sensor suite designed to collect sensor data from the target area, including at least a hyperspectral sensor, a visible-spectrum sensor, and at least one of a thermal sensor or a near-infrared sensor; a processor configured to: perform multi-layer sensing by conducting a first-level scan using a low-resolution sensor to identify regions of interest and conducting a second-level scan using the hyperspectral sensor on the identified regions of interest. run a physics-informed neural network that processes the sensor data to produce a disentangled representation of physical properties of the target area as a latent hypercomplex state with a scalar component and one or more imaginary components, wherein the neural network uses a learnable hypercomplex algebra for operations within the latent hypercomplex state. perform real-time edge processing of the sensor data to enable on-device analysis without transmitting raw data to an external server. a wireless communication module configured to integrate with an external computing device or ground station to transmit processed results or receive control inputs. a GPS/positioning system configured to georeferenced detection results to specific geographic coordinates. where the system is implemented in an unmanned aerial vehicle (UAV) configured to autonomously scan the target area by planning flight paths based on detection results and identified regions of interest

Embodiment 50. A computer-implemented method for spectroscopic detection of a target in a scene, comprising: performing scene data acquisition in progressive scanning levels that include: a first level using broadband lighting with a visible-spectrum sensor to identify regions of interest. a second level using thermal sensing and selected hyperspectral bands to analyze the regions of interest; and a third level using full hyperspectral sensing and near infrared microscopy; setting one or more thresholds for escalating from one level to a next level based on confidence in anomaly detection within the regions of interest. fusing data from the performed levels; and outputting a detection decision for the target based on the fused data.

Embodiment 51. A computer-implemented method for spectroscopic detection of a target in a scene, comprising: acquiring scene data in progressive scanning levels that include multiple levels of sensing to identify and analyze regions of interest. fusing the acquired scene data using feature-level fusion of spectral descriptors, spatial texture metrics, and thermal gradients; applying a classifier trained to detect adulterants to the fused data; and outputting a detection decision for the target based on the fused data.

Embodiment 52. A non-transitory computer-readable medium storing instructions that, when executed by one or more processors, cause the processors to: pre-train a spectral reconstruction subnetwork by masking contiguous wavelength intervals of an input spectrum and predicting the masked intervals from unmasked portions subject to physics regularizers that enforce (i) non-negativity and spectral smoothness of an attenuation vector and (ii) band-limited support of an emission profile; and fine-tune the subnetwork jointly with a physics-constrained reconstruction module that, from a latent hypercomplex state, computes (i) a base reflectance spectrum, (ii) a multiplicative absorption profile constrained to be non-negative, and (iii) an additive fluorescence profile constrained to be band-limited, and reconstructs a spectrum; and update parameters of a learnable hypercomplex multiplication operator used in latent-space operations, the operator being constrained to maintain a bounded operator norm during training.

Embodiment 53. A non-transitory computer-readable medium storing instructions that, when executed by one or more processors, cause the processors to: pre-train a spectral reconstruction subnetwork by masking contiguous wavelength intervals of an input spectrum, wherein the masking comprises selecting contiguous wavelength intervals whose band length is drawn from a probability distribution calibrated to instrument spectral band spacing, and predicting the masked intervals from unmasked portions using a training loss function that includes (i) a norm of a spectral derivative of an attenuation profile to promote smoothness, and (ii) a penalty that drives an emission profile toward zero outside predefined emission bands; fine-tune the subnetwork jointly with a physics-constrained reconstruction module that, from a latent hypercomplex state, computes (i) a base reflectance spectrum, (ii) a multiplicative absorption profile constrained to be non-negative, and (iii) an additive fluorescence profile constrained to be band-limited, and reconstructs a spectrum; and update parameters of a learnable hypercomplex multiplication operator used in latent-space operations, wherein the learnable hypercomplex multiplication operator is regularized toward orthogonality by minimizing a deviation measure during training.

Embodiment 54. A non-transitory computer-readable medium storing instructions that, when executed by one or more processors, cause the processors to: control progressive multi-level acquisition comprising: acquiring a first level scan using broadband lighting with a visible-spectrum sensor to identify regions of interest; acquiring a second level scan using thermal sensing and selected hyperspectral bands to analyze the regions of interest; acquiring a third level scan using full hyperspectral sensing and near-infrared microscopy; fusing data from the performed levels; and generating a detection decision for a target based on the fused data; wherein the first level scan, second level scan, and third level scan are acquired by a multi-modal sensor suite comprising at least a hyperspectral sensor and a visible-spectrum sensor during progressive scanning; and apply a hypercomplex phase-difference activation by computing phase differences between at least one imaginary component and a scalar component of a hypercomplex input state, applying an activation function of the phase differences to produce an activated state, and supplying the activated state to a subsequent network layer.

Embodiment 55. A system comprising: one or more processors; and memory storing instructions that, when executed, cause the processors to perform hypercomplex convolution over grouped spectral bands using a learnable hypercomplex algebra whose multiplication rules are parameterized and optimized during training to improve separation of base material spectra from adulterant signatures, independent of specific neural network architectures; wherein the learnable hypercomplex algebra is represented by a 4×4 parameter matrix constrained by at least one of orthogonality, normalization, or bounded magnitude.

Embodiment 56. A movable scanning device comprising: at least one hyperspectral sensor; at least one environmental sensor; at least one programmable light source; and a drive configured to move or rotate the sensor to scan an extended area; the device is configured to escalate from a coarse visible-light scan to fine hyperspectral analysis of identified regions of interest.

Embodiment 57. A movable scanning device comprising: at least one hyperspectral sensor; at least one environmental sensor; at least one programmable light source; a drive configured to move or rotate the sensor to scan an extended area; a communications interface for wired or wireless data exchange; and wherein the device is embodied as one of: a drone, robot, handheld unit, mounted system, or mobile-device accessory; the device being configured to escalate from a coarse visible-light scan to fine hyperspectral analysis of identified regions of interest.

### Computer System

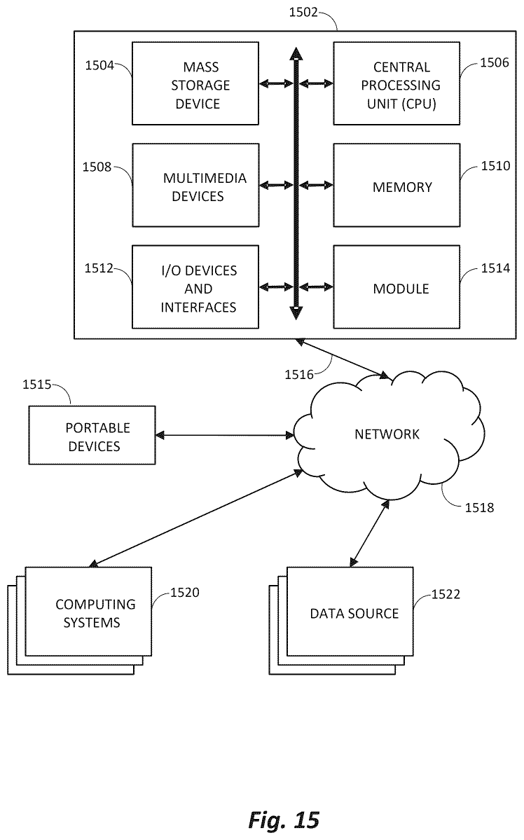

FIG. 15 is a block diagram depicting an embodiment of a computer hardware system 1502 configured to run software for implementing one or more of the systems and methods described herein. The example computer system 1502 is in communication with one or more computing systems 1520 and/or one or more data sources 1522 via one or more networks 1518. While FIG. 15 illustrates an embodiment of a computing system 1502, it is recognized that the functionality provided for in the components and modules of computer system 1502 may be combined into fewer components and modules, or further separated into additional components and modules.

The computer system 1502 can comprise a module 1514 that carries out the functions, methods, acts, and/or processes described herein. The module 1514 is executed on the computer system 1502 by a central processing unit 1506 discussed further below.

In general, the word “module,” as used herein, refers to logic embodied in hardware or firmware or to a collection of software instructions, having entry and exit points. Modules are written in a program language, such as Java, C, C++, Python, or the like. Software modules may be compiled or linked into an executable program, installed in a dynamic link library, or may be written in an interpreted language such as BASIC, PERL, Lua, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in whole or in-part within special designed hardware or firmware. Not all calculations, analysis, and/or optimization require the use of computer systems, though any of the above described methods, calculations, processes, or analyses may be facilitated through the use of computers. Further, in some embodiments, process blocks described herein may be altered, rearranged, combined, and/or omitted.

The computer system 1502 includes one or more processing units (CPU) 1506, which may comprise a microprocessor. The computer system 1502 further includes a physical memory 1510, such as random-access memory (RAM) for temporary storage of information, a read only memory (ROM) for permanent storage of information, and a mass storage device 1504, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1502 are connected to the computer using a standards-based bus system. The bus system can be implemented using various protocols, such as Peripheral Component Interconnect (PCI), Micro Channel, SCSI, Industrial Standard Architecture (ISA), and Extended ISA (EISA) architectures.

The computer system 1502 includes one or more input/output (I/O) devices and interfaces 1512, such as a keyboard, mouse, touch pad, and printer. The I/O devices and interfaces 1512 can include one or more display devices, such as a monitor, which allows the visual presentation of data to a user. More particularly, a display device provides for the presentation of GUIs as application software data, and multimedia presentations, for example. The I/O devices and interfaces 1512 can also provide a communications interface to various external devices. The computer system 1502 may comprise one or more multimedia devices 1508, such as speakers, video cards, graphics accelerators, and microphones, for example.

The computer system 1502 may run on a variety of computing devices, such as a server, a Windows server, a Structured Query Language server, a Unix Server, a personal computer, a laptop computer, and so forth. In other embodiments, the computer system 1502 may run on a cluster computer system, a mainframe computer system, and/or other computing system suitable for controlling and/or communicating with large databases, performing high-volume transaction processing, and generating reports from large databases. The computing system 1502 is generally controlled and coordinated by an operating system software, such as z/OS, Windows, Linux, UNIX, BSD, SunOS, Solaris, macOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 1502 illustrated in FIG. 15 is coupled to a network 1518, such as a LAN, WAN, or the Internet via a communication link 1516 (wired, wireless, or a combination thereof). Network 1518 communicates with various computing devices and/or other electronic devices, such as portable devices 1515. Network 1518 is communicating with one or more computing systems 1520 and one or more data sources 1522. The module 1514 may access or may be accessed by computing systems 1520 and/or data sources 1522 through a web-enabled user access point. Connections may be a direct physical connection, a virtual connection, and other connection type. The web-enabled user access point may comprise a browser module that uses text, graphics, audio, video, and other media to present data and to allow interaction with data via the network 1518.

Access to the module 1514 of the computer system 1502 by computing systems 1520 and/or by data sources 1522 may be through a web-enabled user access point such as the computing systems' 1520 or data source's 1522 personal computer, cellular phone, smartphone, laptop, tablet computer, e-reader device, audio player, or another device capable of connecting to the network 1518. Such a device may have a browser module that is implemented as a module that uses text, graphics, audio, video, and other media to present data and to allow interaction with data via the network 1518.

The output module may be implemented as a combination of an all-points addressable display such as a cathode ray tube (CRT), a liquid crystal display (LCD), a plasma display, or other types and/or combinations of displays. The output module may be implemented to communicate with interfaces 1512 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some implementations, the system 1502 may comprise a physical or logical connection established between a remote microprocessor and a mainframe host computer for the express purpose of uploading, downloading, or viewing interactive data and databases on-line in real time. The remote microprocessor may be operated by an entity operating the computer system 1502, including the client server systems or the main server system, an/or may be operated by one or more of the data sources 1522 and/or one or more of the computing systems 1520. In some implementations, terminal emulation software may be used on the microprocessor for participating in the micro-mainframe link.

In some implementations, computing systems 1520 who are internal to an entity operating the computer system 1502 may access the module 1514 internally as an application or process run by the CPU 1506.

In some implementations, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name, and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the creator. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 1502 may include one or more internal and/or external data sources (for example, data sources 1522). In some implementations, one or more of the data repositories and the data sources described above may be implemented using a relational database, such as DB2, Sybase, Oracle, Code Base, and Microsoft® SQL Server as well as other types of databases such as a flat-file database, an entity relationship database, and object-oriented database, and/or a record-based database.

The computer system 1502 may also access one or more databases 1522. The databases 1522 may be stored in a database or data repository. The computer system 1502 may access the one or more databases 1522 through a network 1518 or may directly access the database or data repository through I/O devices and interfaces 1512. The data repository storing the one or more databases 1522 may reside within the computer system 1502.

### CONCLUSION

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure.

It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above. Moreover, merely because some features, elements, operations, etc., are described as optional does not mean that features, elements, operations, etc., not so described are required.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or operations. Thus, such conditional language is not generally intended to imply that features, elements and/or operations are in any way required for one or more embodiments or that one or more embodiments necessarily include logic for deciding, with or without author input or prompting, whether these features, elements and/or operations are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, Band C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A system for spectroscopic analysis of a target area to detect a target substance, comprising:
a multi-modal sensor suite configured to acquire sensor data from the target area, wherein the sensor suite includes at least a hyperspectral sensor and a visible-spectrum sensor; and
a processor configured to execute a physics-constrained computational model that processes the sensor data to generate a disentangled representation of physical properties of the target area, wherein the disentangled representation is a latent hypercomplex state having a scalar component and one or more imaginary components, and wherein the physics-constrained computational model utilizes a learnable hypercomplex algebra for operations in the latent hypercomplex state, and wherein the learnable hypercomplex algebra is parameterized by trainable structure constants defining multiplication among components of the latent hypercomplex state.

2. The system of claim 1, wherein the multi-modal sensor suite further comprises at least one of a thermal sensor and a near-infrared sensor.

3. The system of claim 1, wherein the processor is further configured to perform multi-level sensing by:
conducting a first-level scan using a low-resolution sensor to identify regions of interest; and
conducting a second-level scan using the hyperspectral sensor on the identified regions of interest.

4. The system of claim 3, wherein the multi-level sensing further comprises a third-level scan using a high-resolution sensor combined with fluorescent lighting on the regions of interest.

5. The system of claim 1, wherein the physics-constrained computational model comprises a spectral disentanglement module configured to map a real-valued spectral vector to the latent hypercomplex state and a physics-constrained reconstruction module configured to compute (i) a base reflectance spectrum, (ii) a multiplicative absorption profile, and (iii) an additive fluorescence profile from respective components of the latent hypercomplex state and to reconstruct a spectrum therefrom.

6. The system of claim 5, wherein the physics-constrained reconstruction module enforces structural constraints modeling physical interactions, wherein a scalar component of the latent hypercomplex state is processed through a multiplicative pathway representing absorption, and at least one imaginary component of the latent hypercomplex state is processed through an additive pathway representing fluorescence.

7. The system of claim 1, wherein the learnable hypercomplex algebra is defined by trainable structure constants that parameterize multiplication among components of the latent hypercomplex state, the structure constants being learned during training.

8. The system of claim 7, wherein the trainable structure constants are constrained during training by at least one of: bounded ranges, normalization, orthogonality, bounded operator norm, or sparsity.

9. The system of claim 1, wherein the physics-constrained computational model utilizes a hypercomplex activation that applies a phase-difference activation computed between at least one imaginary component and the scalar component of an input hypercomplex state to model interdependencies.

10. The system of claim 1, wherein the processor is further configured to train the physics-constrained computational model using a two-stage parameter-estimation regimen comprising:
a masked-wavelength reconstruction subnetwork that predicts omitted contiguous spectral intervals while enforcing non-negativity and spectral smoothness of an attenuation profile and band-limited support of an emission profile; and
physics-constrained fine-tuning in which a generative disentanglement module computes a base reflectance spectrum, a multiplicative absorption profile, and an additive fluorescence profile from components of the latent hypercomplex state and reconstructs a spectrum, while concurrently optimizing parameters of a learnable hypercomplex multiplication operator under one or more regularizers including normalization, orthogonality, sparsity, and bounded operator norm.

11. The system of claim 1, wherein the system is embodied in a handheld device configured to display detection results in real time.

12. The system of claim 1, wherein the processor is further configured to perform real-time edge processing of the sensor data to enable on-device analysis without transmitting raw data to an external server.

13. The system of claim 1, wherein the system is further configured to integrate with an external computing device by wireless communication to transmit processed results or receive control inputs.

14. A computer-implemented method for spectroscopic detection of a target in a scene, comprising:
acquiring scene data at a plurality of progressively escalated scanning levels comprising at least two levels;
at each scanning level of the plurality of scanning levels, evaluating a stopping policy or threshold prior to escalation;
fusing data the scene data; and
outputting a detection decision for the target based on the fused data.

15. The method of claim 14, wherein the progressively escalated scanning levels comprise:
a first level using broadband lighting with a visible-spectrum sensor and near-infrared sensor to identify regions of interest;
a second level using ultraviolet sensing and shortwave-infrared sensing and selected hyperspectral bands to analyze the regions of interest; and
a third level using full hyperspectral sensing and fluorescence sensing.

16. The method of claim 14, wherein fusing comprises feature-level fusion of spectral descriptors, spatial texture metrics, and thermal gradients, followed by a classifier trained to detect a target.

17. A computer-implemented method of reconstructing and analyzing spectra, comprising:
computing, from a real-valued spectral vector, a latent hypercomplex state;
applying a physics-constrained reconstruction that computes, from respective components of the latent hypercomplex state, physically interpretable terms including at least (i) a multiplicative attenuation term constrained to be non-negative and spectrally smooth and (ii) an additive emission term constrained to be band-limited, wherein a spectrum is reconstructed based on the terms; and
classifying a target using at least one of the reconstructed spectrum, an absorption profile, or a fluorescence profile.

18. The method of claim 17, wherein reconstructing the spectrum comprises computing a reconstructed spectrum equal to a product of the base spectrum and the absorption profile plus the fluorescence profile and wherein the physics-constrained reconstruction constrains the attenuation profile to be non-negative and smoothly varying across wavelength and constrains the emission profile to be additive and band-limited.

19. The method of claim 17, wherein at least one operation in computing the latent hypercomplex state or in the physics-constrained reconstruction employs hypercomplex convolution over grouped spectral bands using a learnable hypercomplex algebra.

20. The method of claim 17, wherein at least one layer applies a phase-difference hypercomplex activation computed between at least one imaginary component and a scalar component of the latent hypercomplex state.
